(19) United States
(12) Patent Application Publication
(10) Pub. No.: US 2021/0334764 A1
(43) Pub. Date: Oct. 28, 2021

(54) INFORMATION PROVIDING METHOD

(71) Applicant: Panasonic Intellectual Property Corporation of America, Torrance, CA (US)

(72) Inventors: Masaki YAMAUCHI, San Jose, CA (US); Nanami FUJIWARA, Santa Clara, CA (US)

(21) Appl. No.: 17/220,437

(22) Filed: Apr. 1, 2021

Related U.S. Application Data
(63) Continuation of application No. PCT/JP2019/038853, filed on Oct. 2, 2019.
(60) Provisional application No. 62/740,066, filed on Oct. 2, 2018.
(60) Provisional application No. 62/740,074, filed on Oct. 2, 2018.
(60) Provisional application No. 62/740,125, filed on Oct. 2, 2018.
(60) Provisional application No. 62/739,926, filed on Oct. 2, 2018.

(51) Int. Cl. G06Q 10/10

(52) U.S. Cl. CPC G06Q 10/1097

(57) ABSTRACT

An information providing method includes: generating first information indicating a high probability that a user is tired when (i) a second return time, indicating when the user returned home in a past second period, is later than a first return time, indicating when a user returned home in a past, longer first period, by a first threshold or longer, and (ii) movement information indicates the user has not moved in the home for a second threshold amount of time or longer; obtaining, from a second information processing apparatus connected to a first information processing apparatus, information indicating first request content over a network; and when the first information content is included in the first request content, outputting, to the second information processing apparatus, second information including information for identifying the user or the home, using the generated first information.

### CROSS REFERENCE TO RELATED APPLICATIONS

This is a continuation application of PCT International Application No. PCT/JP2019/038853 filed on Oct. 2, 2019, designating the United States of America, which is based on and claims priority of U.S. Provisional Patent Application No. 62/739,926 filed on Oct. 2, 2018, U.S. Provisional Patent Application No. 62/740,066 filed on Oct. 2, 2018, U.S. Provisional Patent Application No. 62/740,074 filed on Oct. 2, 2018, and U.S. Provisional Patent Application No. 62/740,125 filed on Oct. 2, 2018. The entire disclosures of the above-identified applications, including the specifications, drawings, and claims are incorporated herein by reference in their entirety.

### FIELD

The present disclosure relates to an information providing method.

### BACKGROUND

In recent years it has become possible to collect a large amount of sensor data from sensors placed in various places, and thus there is a demand to effectively use the collected sensor data. For example, if sensor data from various sensors placed in an indoor space such as a house is used, it is possible to provide services suitable to the user's situation (for example, see Japanese Patent Application Publication No. 2018-32272).

### SUMMARY

### Technical Problem

However, with the conventional art, there is little information that is related to how to use the sensor data, and it is therefore difficult to effectively use the sensor data for providing services.

The present disclosure provides, for example, an information providing method that can effectively use sensor data for providing services.

### Solutions to Problem

An information providing method according to one aspect of the present disclosure is a method that uses a first information processing apparatus which includes a processor and memory. A sensor is disposed in a home. The processor: obtains, from the memory, information indicating a first return time indicating a time a user returned to the home in a first period in the past; obtains, from the memory, information indicating a second return time indicating a time the user returned to the home in a second period in the past, the second period being shorter than the first period; obtains movement information on the user, based on a sensor value of the sensor; when (i) the second return time is later than the first return time by a first threshold amount of time or longer and (ii) the movement information indicates that the user has not moved in the home for a second threshold amount of time or longer, generates first information indicating a high probability that the user is tired; obtains, from a second information processing apparatus connected to the first information processing apparatus, information indicating first request content over a network; and when content of the first information is included in the first request content, outputs, to the second information processing apparatus, second information including information for identifying the user or the home, using the first information generated.

An information providing method according to one aspect of the present disclosure is a method that uses a first information processing apparatus which includes a processor and memory. An electronic device and a sensor are disposed in a dining space of a home. The processor: obtains, from the memory, past sensing statistical information corresponding to the dining space; obtains current sensing information corresponding to the dining space via the sensor; when (viii) a first time is later than a second time by a given amount of time or longer, generates first information indicating that an activity of a user is more delayed than usual, the first time being included in the current sensing information and indicating at least one of the user being present in the dining space or the electronic device being active, the second time being included in the past sensing statistical information and indicating at least one of the user being present in the dining space or the electronic device being active; obtains, from a second information processing apparatus connected to the first information processing apparatus, information indicating first request content over a network; and when content of the first information is included in the first request content, outputs, to the second information processing apparatus, second information including information for identifying the user or the home, using the first information generated.

An information providing method according to one aspect of the present disclosure is a method that uses a first information processing apparatus which includes a processor and memory. An electronic device and a sensor are disposed in a first space including at least one of an entrance space or a dining space of a home. The processor: obtains, from the memory, past sensing statistical information corresponding to the first space; obtains current sensing information corresponding to the first space via the sensor; when (ix) a first amount of time is longer than a second amount of time by a given amount of time or longer, generates first information indicating that a user has been in the first space for longer than usual, the first amount of time being included in current sensing information and indicating at least one of an amount of time that the user has been present in the first space or an amount of time that the electronic device been active, the second amount of time being included in past sensing statistical information and indicating at least one of an amount of time that the user was present in the first space or an amount of time that the electronic device was active, obtains, from a second information processing apparatus connected to the first information processing apparatus, information indicating first request content over a network; and when content of the first information is included in the first request content, outputs, to the second information processing apparatus, second information including information for identifying the user or the home, using the first information generated.

An information providing method according to one aspect of the present disclosure is a method that uses a first information processing apparatus which includes a processor and memory. A sensor is disposed in an entrance space of a home. The processor: obtains, from the memory, past sensing statistical information corresponding to the entrance space; obtains current sensing information corresponding to the entrance space via the sensor; when (x) a time at which a user returned home that is included in the current sensing information is earlier than a time at which the user returned home that is included in the past sensing statistical information by a threshold amount of time or longer, generates first information indicating that the user has returned home earlier than usual; obtains, from a second information processing apparatus connected to the first information processing apparatus, information indicating first request content over a network; and when content of the first information is included in the first request content, outputs, to the second information processing apparatus, second information including information for identifying the user or the home, using the first information generated.

General and specific aspect(s) disclosed above may be implemented using a system, an apparatus, an integrated circuit, a computer program, or a computer-readable recording medium such as a CD-ROM, or any combination thereof.

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

### Advantageous Effects

The information providing method according to one aspect of the present disclosure can effectively use sensor data for providing services.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates an overview of the service providing system according to Embodiment 1.

FIG. 2 illustrates the configuration of the service providing system according to Embodiment 1.

FIG. 3 illustrates the functional configurations of the first information processing apparatus and the second information processing apparatus according to Embodiment 1.

FIG. 4 is a sequence diagram for the service providing system according to Embodiment 1.

FIG. 5 is a flow chart illustrating processes performed by the first information processing apparatus according to Embodiment 1.

FIG. 6 is a flow chart illustrating one example of the determination process for the first condition according to Embodiment 1.

FIG. 7 illustrates one example of first sensor data related to the presence of the user in the space according to Embodiment 1.

FIG. 8 illustrates one example of daily return times according to Embodiment 1.

FIG. 9 illustrates one example of first sensor data related to the location of the user in the space according to Embodiment 1.

FIG. 10 illustrates one example of the weather information according to Embodiment 1.

FIG. 11 is a flow chart illustrating a first variation of the determination process for the first condition according to Embodiment 1,

FIG. 12 is a flow chart illustrating a second variation of the determination process for the first condition according to Embodiment 1.

FIG. 13 is a flow chart illustrating a third variation of the determination process for the first condition according to Embodiment 1.

FIG. 14 illustrates one example of daily user bedtimes according to Embodiment 1.

FIG. 15 is a flow chart illustrating one example of the determination process for the first condition according to Embodiment 2,

FIG. 16 illustrates one example of past sensing information related to the activity of an electronic device according to Embodiment 2.

FIG. 17 illustrates one example of past sensing information related to the opening and closing of a door of a refrigerator according to Embodiment 2.

FIG. 18 illustrates one example of past sensing information obtained by the motion sensor according to Embodiment 2.

FIG. 19 is a flow chart illustrating one example of the determination process for the first condition according to Embodiment 3.

FIG. 20 is a flow chart illustrating one example of the determination process for the first condition according to Embodiment 4.

FIG. 21 is a sequence diagram for the service providing system according to Variation 1.

FIG. 22 is a sequence diagram for the service providing system according to Variation 2.

FIG. 23 is a flow chart illustrating one example of the process for generating the second information according to Variation 3.

FIG. 24A illustrates one example of relationships between services and the five senses according to Variation 3.

FIG. 24B illustrates one example of relationships between devices and the five senses according to Variation 3.

FIG. 25 is a flow chart illustrating one example of the process for generating the second information according to Variation 4.

FIG. 26 illustrates one example of the service provision history according to Variation 4.

FIG. 27A illustrates one example of service provision availability information according to Variation 4.

FIG. 27B illustrates one example of information indicating services that are prohibited from being provided simultaneously according to Variation 4.

FIG. 27C illustrates one example of information indicating services that are prohibited from being changed according to Variation 4.

FIG. 28 is a flow chart illustrating one example of the process for outputting the second information according to Variation 5.

FIG. 29A illustrates an overview of the service providing system.

FIG. 29B illustrates one example of the data center operating company.

FIG. 29C illustrates one example of the data center operating company.

FIG. 30 illustrates service type 1 (in-company data center).

FIG. 31 illustrates service type 2 (IaaS).

FIG. 32 illustrates service type 3 (PaaS).

FIG. 33 illustrates service type 4 (SaaS).

### DESCRIPTION OF EMBODIMENTS

Hereinafter, embodiments are specifically described with reference to the drawings.

Each of the following embodiments describes a general or specific example. The numerical values, shapes, materials, elements, the arrangement and connection of the elements, steps, order of the steps, etc., shown in the following embodiments are mere examples, and therefore do not limit the scope of the claims.

The figures are not necessarily precise illustrations. In the figures, elements that are essentially the same share like reference signs. Accordingly, duplicate description thereof is omitted or simplified.

### Embodiment 1

### Overview of Service Providing System 10

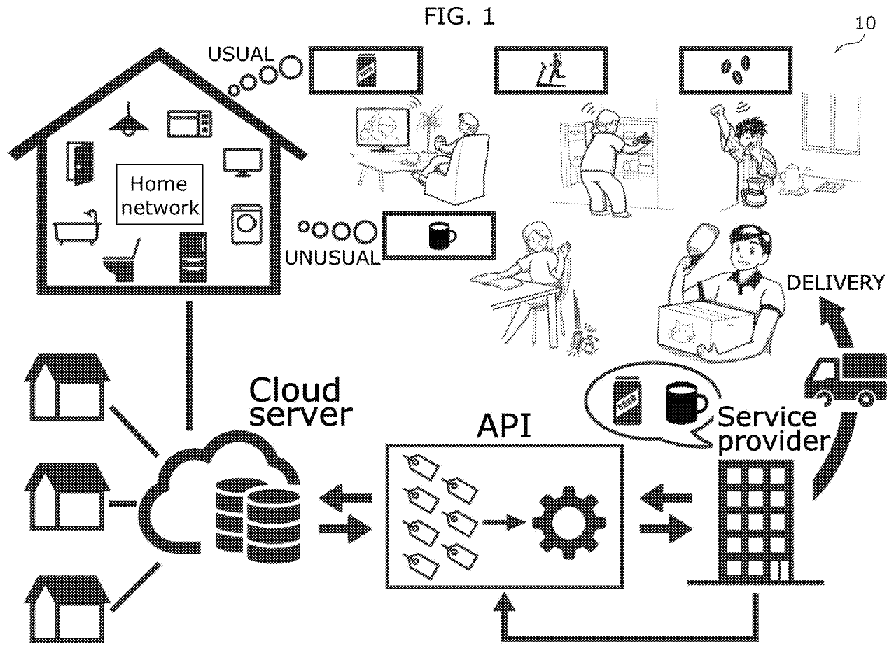

First, an overview of service providing system 10 will be described with reference to FIG. 1. FIG. 1 illustrates an overview of service providing system 10 according to Embodiment 1.

In service providing system 10 according to the present embodiment, sensor data from a plurality of indoor spaces is collected by a cloud server. Examples of an indoor space include a home, an office, a building, and the inside of a vehicle. Sensor data is data based on usual activity and/or unusual activity of a user in an indoor space.

Via an application programming interface (API), each of a plurality of service providers is capable of obtaining various information based on sensor data collected by the cloud server. An API is an information processing function of a cloud server that can be called from a computer and used.

Each service provider provides a service to a user based on information obtained via the API. Examples of services include an information providing service, an advertisement delivery service, a service for automated control of devices on a home network, or any combination thereof. Note that the service is not limited to these examples. For example, the service may be a product delivery service.

### Configuration of Service Providing System 10

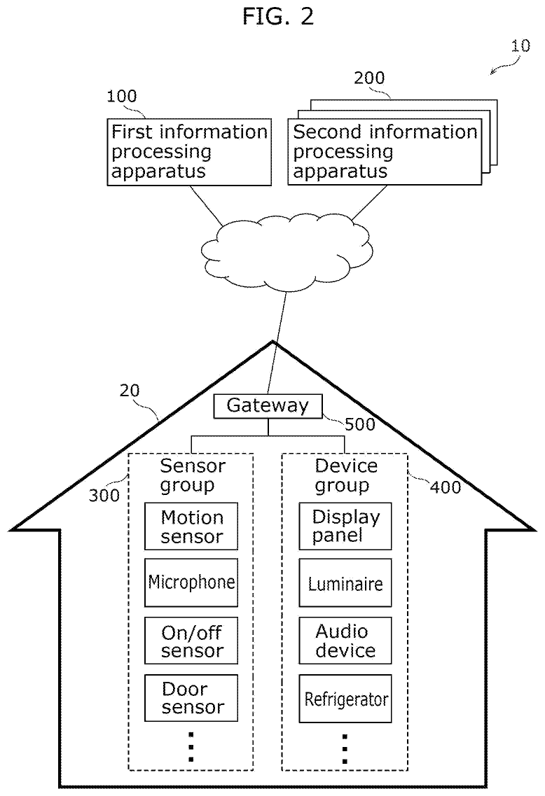

Next, the configuration of service providing system 10 will be described with reference to FIG. 2. FIG. 2 illustrates a configuration of service providing system 10 according to Embodiment 1. As illustrated in FIG. 2, service providing system 10 according to the present embodiment includes first information processing apparatus 100, second information processing apparatus 200, sensor group 300, and device group 400.

Sensor group 300 is disposed in space 20, and includes at least one sensor. Sensor group 300 is connected to a communications network such as the internet via gateway 500. Note that gateway 500 is optional; sensor group 300 may be connected to a communications network without passing through gateway 500.

Sensor group 300 outputs a sensor value indicating, for example, movement information related to a movement of a user or information related to activity/user operation of device group 400. For example, sensor group 300 can output a sensor value indicating whether a luminaire is emitting light, a sensor value indicating whether an audio device is outputting sound, a sensor value indicating whether a user is present in space 20 or a predefined region of space 20, or any combination thereof.

Sensor group 300 can include, for example, a motion sensor, a door sensor, a sound sensor, or any combination thereof. Such sensors included in sensor group 300 can be realized as, for example, an image sensor, an infrared sensor, an ultrasound sensor, a visible light sensor, a vibration sensor, a touch sensor, a microphone, or any combination thereof. Such sensors can be provided on a wall, floor, or ceiling that defines space 20, or on an electronic device or furniture disposed in space 20. Moreover, the sensors may be provided in devices included in device group 400. For example, one sensor may be a touch sensor provided in the touch screen of a smartphone or the like. Note that the sensors are not limited to the above examples.

Device group 400 is disposed in space 20, and includes at least one electronic device. Device group 400 is connected to a communications network such as the internet via gateway 500. Note that gateway 500 is optional; device group 400 may be connected to a communications network without passing through gateway 500.

Device group 400 can include, for example, a display panel, a luminaire, an audio device, a refrigerator, a vacuum cleaner, or any combination thereof. Note that the one or more devices included in device group 400 are not limited to these examples.

First information processing apparatus 100 is disposed outside of space 20 and includes a processor and memory. For example, first information processing apparatus 100 corresponds to the cloud server illustrated in FIG. 1. Note that first information processing apparatus 100 may be an edge server disposed in space 20.

Note that a cloud server refers to a server that is provided over the internet. An edge server refers to a server that is provided over a network in an area closer to the user than the internet is (such as a local area network (LAN)).

Second information processing apparatus 200 includes a processor and memory. For example, second information processing apparatus 200 is the service provider illustrated in FIG. 1. Second information processing apparatus 200 provides a service to a user via device group 400 in space 20.

This example assumes that service providing system 10 illustrated in FIG. 2 is provided in each of a plurality of indoor spaces. More specifically, first information processing apparatus 100 is provided for each of a plurality of indoor spaces, and a plurality of second information processing apparatuses 200 are connected to each first information processing apparatus 100 to provide services to each indoor space. Here, the aim is to provide of a variety of information regarding users or spaces 20 from the plurality of first information processing apparatuses 100, and to provide a variety of services using the plurality of second information processing apparatuses 200, by providing a plurality of first information processing apparatuses 100 and a plurality of second information processing apparatuses 200 individual of one another. However, new information is exchanged between the plurality of first information processing apparatuses 100 and the plurality of second information processing apparatuses 200. The present embodiment provides a system which effectively uses sensor data and provides appropriate services, by defining the exchange of such information.

### Functional Configuration of First Information Processing Apparatus 100

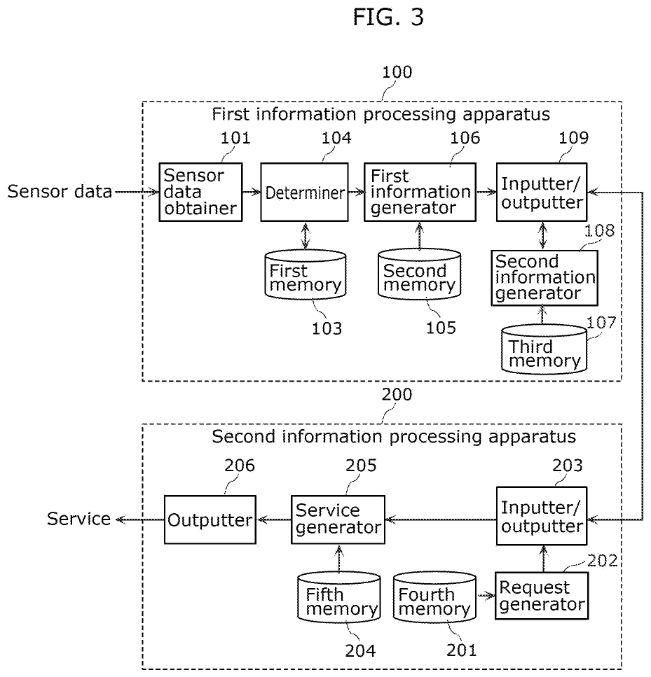

Next, the functional configuration of first information processing apparatus 100 will be described with reference to FIG. 3, FIG. 3 illustrates the functional configurations of first information processing apparatus 100 and second information processing apparatus 200 according to Embodiment 1.

As illustrated in FIG. 3, first information processing apparatus 100 according to the present embodiment includes sensor data obtainer 101, first memory 103, determiner 104, second memory 105, first information generator 106, third memory 107, second information generator 108, and inputter/outputter 109. Next, the functional blocks of first information processing apparatus 100 will be described.

Sensor data obtainer 101 obtains first sensor data including a first sensor value from sensor group 300. Part or all of first sensor data is stored in first memory 103. First sensor data may include data indicating whether a person is present in a given region in space 20, for example. First sensor data may include data indicating a state of sound output of an audio device, for example. First sensor data may include data indicating an operation state of a device. First sensor data may include data indicating whether a door of a refrigerator is open or closed.

First memory 103 stores part or all of the first sensor data obtained by sensor data obtainer 101.

Determiner 104 determines whether a first condition is satisfied or not. The first condition will be described in greater detail later.

Second memory 105 stores information for generating the first information. For example, second memory 105 stores a correspondence table in which content of the generated information is associated with mutually different conditions.

First information generator 106 generates first information when the first condition is satisfied. In the present embodiment, the first information indicates that there is a high probability that the user is tired, but the first information is not limited to this example.

Third memory 107 stores information for generating second information. In other words, third memory 107 stores information for identifying the user or space 20 corresponding to the first information generated by first information generator 106.

Second information generator 108 determines whether content of the first information is included in first request content included in information obtained from second information processing apparatus 200 via inputter/outputter 109. When content of the first information is included in the first request content, second information generator 108 generates the second information using the first information. The second information includes information for identifying the user or space 20 (for example, a user ID, a home address, an IP address, device identification information, etc.). For example, second information generator 108 generates the second information by reading, from third memory 107, information for identifying the user or space 20 corresponding to the first information generated by first information generator 106. Here, the second information may be information required for providing a service to the user or space 20. When content of the service to be provided is included in the first request, the second information corresponding to the content of the service may be provided. In a case in which the service is to be provided using a communications environment, one example of the second information is an IP address. In a case in which the service to be provided is for controlling a device, one example of the second information is device identification information. In a case in which the service to be provided is for controlling a device using a communications environment, one example of second information may be a combination of an IP address and device identification information.

Inputter/outputter 109 obtains information indicating the first request content (hereinafter “first request information”) from second information processing apparatus 200 connected to first information processing apparatus 100 over a network. Inputter/outputter 109 further outputs the second information generated by second information generator 108 to second information processing apparatus 200.

Note that determiner 104, first information generator 106, and second information generator 108 described above are realized as, for example, a processor and memory. When an instruction or a software program that is stored in the memory is executed, the processor functions as determiner 104, first information generator 106, and second information generator 108. Determiner 104, first information generator 106, and second information generator 108 may be realized as dedicated electronic circuitry.

First memory 103, second memory 105, and third memory 107 described above are realized as, for example, semiconductor memory and/or a disk drive or the like. Inputter/outputter 109 is realized as, for example, a network interface controller (NIC) or the like.

### Functional Configuration of Second Information Processing Apparatus 200

Next, the functional configuration of second information processing apparatus 200 will be described with reference to FIG. 3.

As illustrated in FIG. 3, second information processing apparatus 200 according to the present embodiment includes fourth memory 201, request generator 202, inputter/outputter 203, fifth memory 204, service generator 205, and outputter 206. Next, the functional blocks of second information processing apparatus 200 will be described.

Fourth memory 201 stores information for generating the first request information.

Request generator 202 generates the first request information. More specifically, request generator 202 references information stored in fourth memory 201 to generate the first request information indicating the first request content.

The first request content indicates requirements that a user or space to which a given service is provided should meet. In the present embodiment, the first request content indicates a requirement of a high probability that the user in space 20 is tired, but the first information is not limited to this example.

Inputter/outputter 203 outputs the first request information generated by request generator 202 to first information processing apparatus 100. Inputter/outputter 203 further obtains the second information from first information processing apparatus 100.

Fifth memory 204 stores information for generating service information. For example, fifth memory 204 stores a correspondence table in which service content is associated with mutually different request content.

Service generator 205 generates first service information using the second information. The first service information is information for providing a service to the user in space 20 via device group 400.

In the present embodiment, the first service information is control information for causing an audio device to reproduce the sound of rain. Moreover, for example, the first service information may be information to be displayed on a display panel. Examples of information to be displayed on the display panel include information related to aroma therapy for improving wellness of the mind and body, information related to exercise for refreshing oneself, information for introducing a coffee bean roasting kit and coffee beans, or any combination thereof. Note that the first service information is not limited to the above examples.

Note that “service information” may also be referred to as “service content”. Service content includes service information such as music or advertisement information, and device control information for providing the service.

Outputter 206 references the second information and outputs the service information generated by service generator 205 to device group 400. Note that second information processing apparatus 200 may include memory for recording the association between information corresponding to the second information and information required for providing the service, obtain information required for providing the service by referencing the second information, and provide the service to the user or space 20.

Request generator 202 and service generator 205 described above are realized as, for example, a processor and memory. When an instruction or a software program that is stored in the memory is executed, the processor functions as request generator 202 and service generator 205. Request generator 202 and service generator 205 may be realized as dedicated electronic circuitry.

Fourth memory 201 and fifth memory 204 described above are realized as, for example, semiconductor memory and/or a disk drive or the like. Inputter/outputter 203 and outputter 206 are realized as, for example, a network interface controller (NIC) or the like.

### Interaction in Service Providing System 10

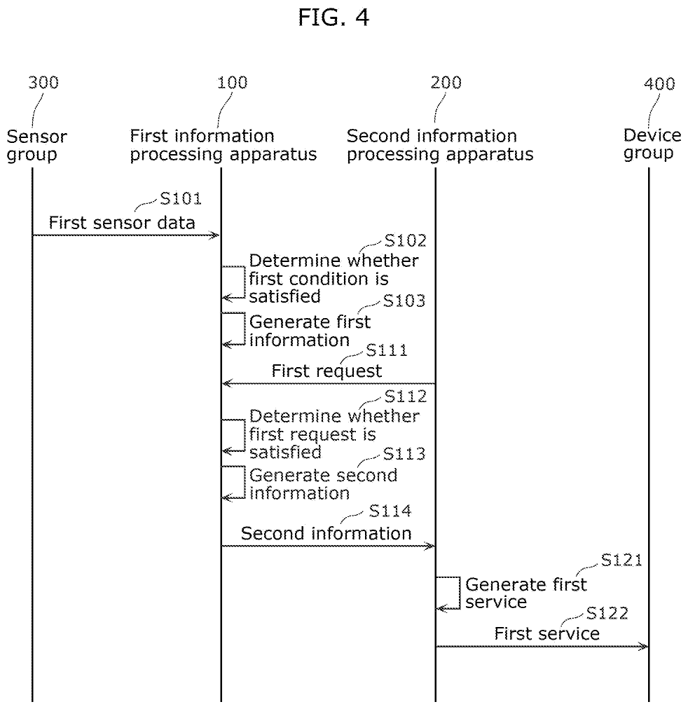

Next, interaction in service providing system 10 will be described with reference to FIG. 4. FIG. 4 is a sequence diagram for service providing system 10 according to Embodiment 1.

As illustrated in FIG. 4, first information processing apparatus 100 obtains the first sensor data including the first sensor value from sensor group 300 (S101). First information processing apparatus 100 determines whether the first condition is satisfied based on the first sensor data (S102). Stated differently, the obtainment of the first sensor data can be said to be trigger information for determining whether the first condition is satisfied. If the first condition is satisfied, first information processing apparatus 100 generates the first information (S103). The first sensor data that serves as the trigger information for determining whether the first condition is satisfied is used in the determining of whether the first condition is satisfied. In other words, in addition to being used as trigger information, the first sensor data can be used in the determining of whether the first condition is satisfied, which corresponds to a condition for providing a service. Moreover, first sensor data that served as trigger information for determining whether the first condition is satisfied in the past may be used in the determining whether the first condition is satisfied.

Here, if first information processing apparatus 100 obtains the first request information from second information processing apparatus 200 (S111), first information processing apparatus 100 determines whether there is a user or space that satisfies the first request content (S112). If first information processing apparatus 100 determines that there is a user or space that satisfies the first request content, first information processing apparatus 100 generates the second information (S113). First information processing apparatus 100 then outputs the generated second information to second information processing apparatus 200 (S114).

Second information processing apparatus 200 generates the first service information based on the second information (S121). The first service information is information for providing a first service to the user in space 20 via device group 400. Second information processing apparatus 200 then outputs the first service information to device group 400 (S122).

Note that the sequence diagram illustrated in FIG. 4 is a non-limiting example. Moreover, the order of the processes in FIG. 4 may be changed.

### Processes Performed by First Information Processing Apparatus 100

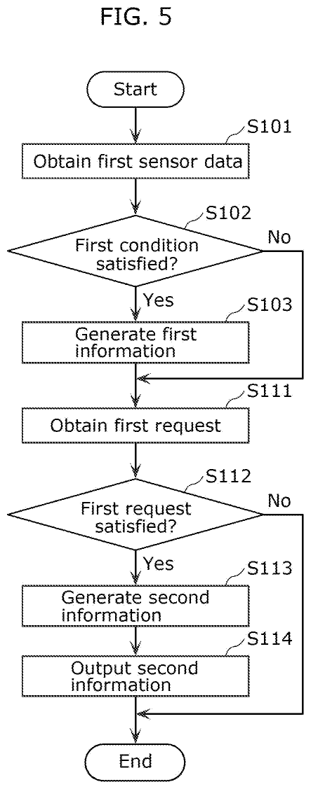

Next, processes performed by first information processing apparatus 100 (i.e., the information providing method) will be described in greater detail with reference to FIG. 5. FIG. 5 is a flow chart illustrating processes performed by first information processing apparatus 100 according to Embodiment 1.

As illustrated in FIG. 5, sensor data obtainer 101 obtains the first sensor data including the first sensor value from sensor group 300 disposed in space 20 (S101). Determiner 104 determines whether the first condition is satisfied based on the first sensor data (S102). This determination process will be described in greater detail later with reference to the figures.

If the first condition is satisfied (Yes in S102), first information generator 106 generates the first information (S103). If the first condition is not satisfied (No in S102), first information generator 106 skips the process for generating the first information, that is to say, first information generator 106 does not generate the first information.

Next, inputter/outputter 109 obtains the first request information indicating the first request content from second information processing apparatus 200 (S111). Second information generator 108 determines whether there is a user or space that matches the first request content (S112). In other words, second information generator 108 determines whether the first request content includes the content of the first information or not.

When second information generator 108 determines that there is a user or space that matches the first request content (Yes in S112), second information generator 108 generates the second information using the generated first information (S113), Inputter/outputter 203 then outputs the generated second information to second information processing apparatus 200 (S114). When second information generator 108 determines that there is not a user or space that matches the first request content (No in S112), second information generator 108 skips the processes for generating and outputting the second information. In other words, second information generator 108 does not generate and output the second information.

### First Condition Determination Process

In the present embodiment, the first condition includes at least (i) and (ii) described below.

(i) A second return time is later than a first return time by a first threshold amount of time or longer. As used herein, the first return time refers to the time that the user returned to space 20 in a first period in the past. As used herein, the second return time refers to the time that the user returned to space 20 in a second period in the past which is shorter than the first period.
(ii) The user has not moved in space 20 for a second threshold amount of time or longer.

In addition to (i) and (ii) described above, the first condition may include (iii) described below.

(iii) The user is within a range of a given distance from a chair or sofa.

The first condition may further include the following.
The weather information indicates cloudy.
It is quiet in the space.

If at least (i) and (ii) described above are satisfied, it is estimated that the user has returned later than usual, the user is exhibiting little movement, and the user is somewhat tired.

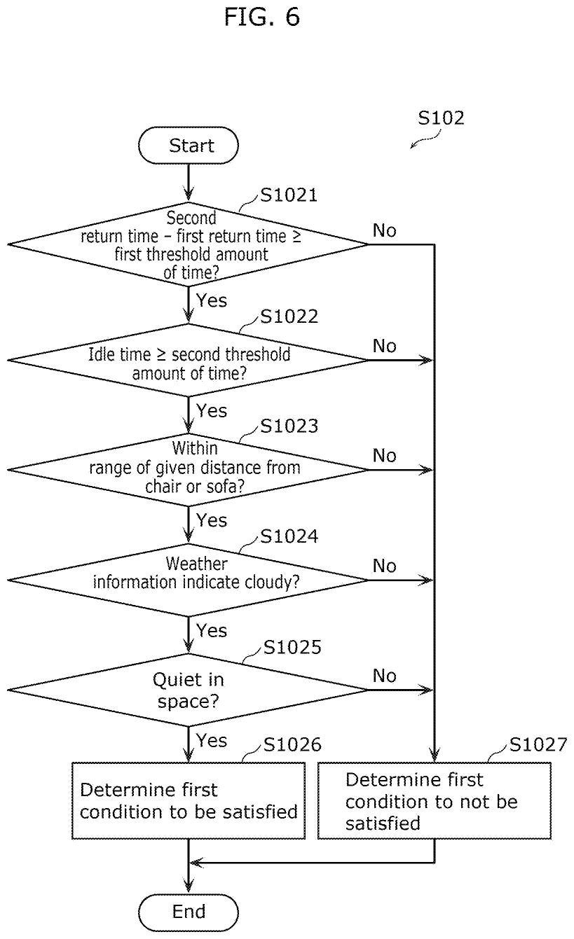

Next, the determination process for such a first condition (S102 in FIG. 5) will be described in greater detail with reference to FIG. 6. FIG. 6 is a flow chart illustrating one example of the determination process for the first condition according to Embodiment 1.

First, determiner 104 determines whether the second return time is later than the first return time by the first threshold amount of time, based on the first sensor data (S1021). In other words, determiner 104 determines whether the amount of time calculated by subtracting the first return time from the second return time is longer than or equal to the first threshold amount of time. Stated differently, determiner 104 determines whether (i) described above is satisfied or not. Information indicating the first return time and information indicating the second return time are obtained from first memory 103.

The first threshold amount of time is an amount of delay for discerning whether the user's return is late or not. An empirically or experimentally predefined time may be used as the first threshold amount of time, and, alternatively, a time input in advance by the user may be used as the first threshold amount of time. The first threshold amount of time may be decided based on past return times. For example, the first threshold amount of time may be decided based on a distribution value of past return times.

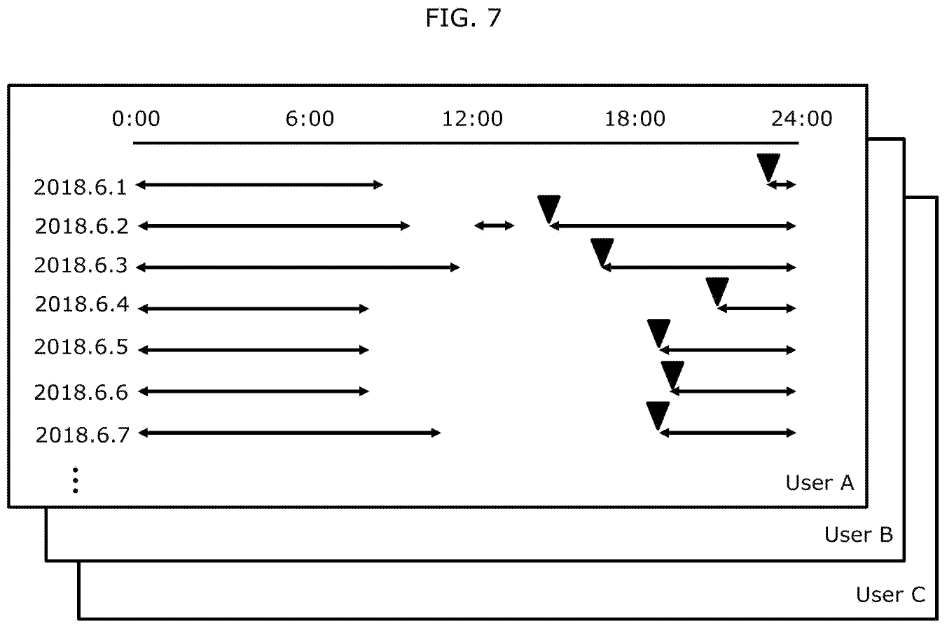

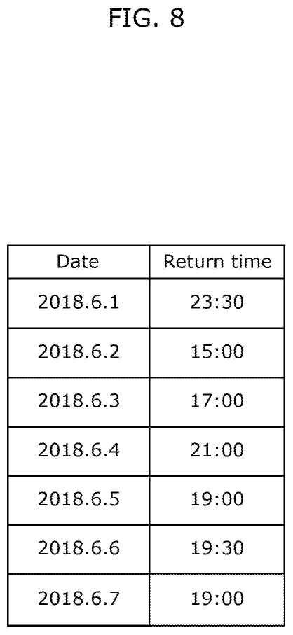

Next, the first return time and the second return time will be described in greater detail with reference to FIG. 7 and FIG. 8.

FIG. 7 illustrates one example of first sensor data related to the presence of the user in space 20 according to Embodiment 1. In FIG. 7, time is represented on the horizontal axis, and days are represented on the vertical axis. The double-headed arrows indicate periods in which the user is home. Such first sensor data can be obtained by, for example, a motion sensor, a GPS sensor, and a front door lock sensor.

In the first sensor data illustrated in FIG. 7, a “return time” is derived as the start time (indicated by the left-side arrow of the double-headed arrows) of a present period, which is a period in which the user is present in the home, that follows an absent period, which is a period in which the user is not present in the home, of a given length of time or longer (for example, 10 minutes). Here, when a plurality of return times are derived in a single day, the latest return time among the plurality of return times is used as the return time for that day (indicated by the triangle mark).

FIG. 8 illustrates one example of daily return times according to Embodiment 1. FIG. 8 illustrates the return time for each day from Jun. 1, 2018 to Jun. 7, 2018. Note that the return time need not be the exact return time; the return time may be a time rounded to a given unit of time (for example, 10 minutes, 30 minutes, or one hour).

Using the above-described daily return times, a statistical value (for example, the average value or the mean value) of return times over the first period in the past (for example, a week, a month, or three months back from the current day, or the same month from last year) is calculated as the first return time. A statistical value (for example, the average value or the mean value) of return times over the second period in the past (for example, a day, three days, or a week back from the current day) is calculated as the second return time.

Here, a period that is shorter than the first period is used as the second period. For example, when the first period is from one week ago to the current day, a period from three days ago to the current day is used as the second period. Accordingly, the first return time represents a trend of long-term return times and the second return time represents a trend of short-term return times. Such first return times and second return times are stored in first memory 103.

Outlier values may be removed from the population when statistical values for the first return time and second return time are calculated. An outlier value can be calculated using, for example, a known statistics method. Furthermore, return times corresponding to weekdays or holidays may be removed from the population when statistical values for the first return time and second return time are calculated.

We will now return to the description of the flowchart illustrated in FIG. 6. When the second return time is later than the first return time by the first threshold amount of time or longer (Yes in S1021), determiner 104 determiners whether the user's idle time is the second threshold amount of time or longer (S1022). In other words, determiner 104 determines whether (ii) described above is satisfied or not.

The second threshold amount of time is an amount of idle time the user is not moving, and is for discerning whether the user is active or not. An empirically or experimentally predefined time may be used as the second threshold amount of time, and, alternatively, a time input in advance by the user may be used as the second threshold amount of time. The second threshold amount of time may be decided based on past user movement.

For example, determiner 104 obtains movement information based on the first sensor data. Determiner 104 then determines, based on the movement information, whether an amount of time indicating that the user is not moving (i.e., is idle) has continued for the second threshold amount of time or longer up to the current time. Note that the user not moving (i.e., being idle) includes, in addition to a state in which the user's amount of movement is precisely zero, states in which the user's amount of movement is lower than a threshold amount of movement. Here, the threshold amount of movement may be empirically or experimentally predefined.

When the user's idle time is the second threshold amount of time or longer (Yes in S1022), determiner 104 determines whether the user is within a range of a given distance from a chair or sofa (S1023). In other words, determiner 104 determines whether (iii) described above is satisfied or not.

For example, determiner 104 obtains, from first memory 103, map data for inside space 20 including information indicating the location of a chair or sofa. Determiner 104 further obtains information indicating the location of the user from first memory 103. Determiner 104 then determines whether the distance between the location of the user and the location of the chair or sofa is less than or equal to the given distance. If the distance is less than or equal to the given distance, determiner 104 determines that the user is within the range of the given distance from a chair or sofa, and if the distance is greater than the given distance, determiner 104 determines that the user is not within the range of the given distance from a chair or sofa.

The given distance is used to discern whether the user is sitting in or leaning on a chair or sofa. For example, an empirically or experimentally predefined distance may be used as the given distance, and, alternatively, a distance that varies depending on the room in which the chair or sofa is disposed may be used as the given distance.

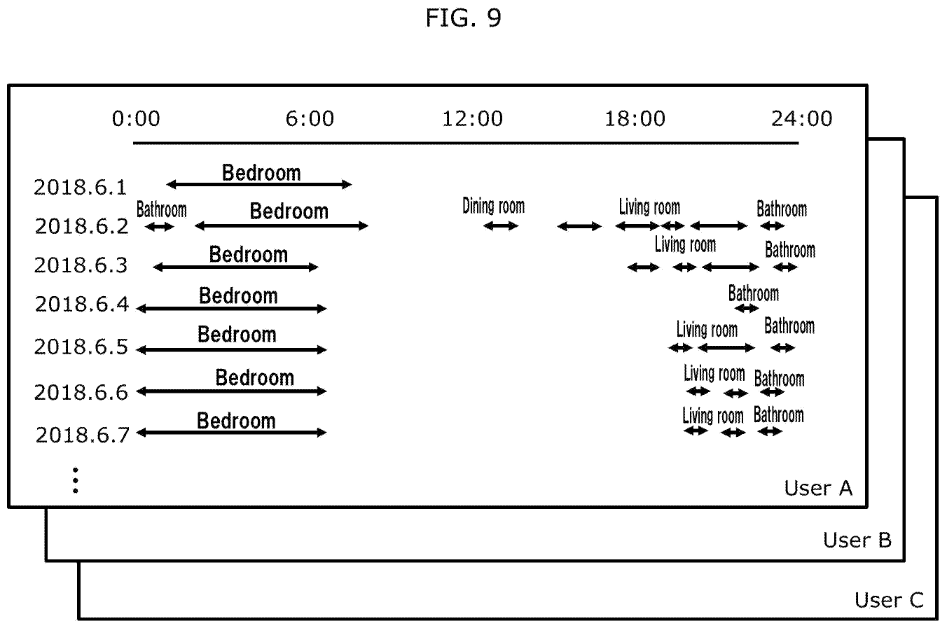

For example, the information indicating the user's location is obtained based on first sensor data related to the user's location in space 20. FIG. 9 illustrates one example of first sensor data related to the location of the user in space 20 according to Embodiment 1. In FIG. 9, time is represented on the horizontal axis, and days are represented on the vertical axis. The double-headed arrows indicate time spent in various locations in space 20. Such first sensor data can be obtained by, for example, a motion sensor, a GPS sensor, and a front door lock sensor, and can also be obtained by user input.

The combination of steps S1022 and S1023 allows determiner 104 to determine that the user has not moved for the second threshold amount of time or longer within the range of the given distance from a chair or sofa.

When the user is in the range of the given distance from a chair or sofa (Yes in S1023), determiner 104 determines whether the weather information indicates cloudy (S1024). More specifically, determiner 104 determines whether the weather for the current day indicates cloudy based on, for example, periodic weather information obtained from an external server or a sensor disposed outside space 20.

The weather forecast with the longest length of time during the current data can be used as the weather forecast for the current day. For example, when 9 of the 24 hours of the day indicate rain and the remaining 15 hours indicate clear skies, “clear skies” may be used as the weather forecast for the current day.

Moreover, the weather forecast with the longest length of time among given time intervals may be used as the weather forecast for the current day. The given time interval may be a time interval set in advance by the user, and may be a time interval in which the user has left space 20.

Moreover, the weather forecast having a high, predefined priority level which corresponds to a threshold length of time or longer in the current day may be used as the weather forecast for the current day. For example, when a high priority level weather forecast indicates rain and the threshold length of time is three hours, if the weather forecast of rain is for three or more hours in the current day, rain may be used as the weather forecast for the current day even if the length of time of the forecast of cloudy is longer than the length of time of the forecast for rain. The threshold length of time and the high priority level weather forecast may be predefined empirically or experimentally, and, alternatively, may be set by the user.

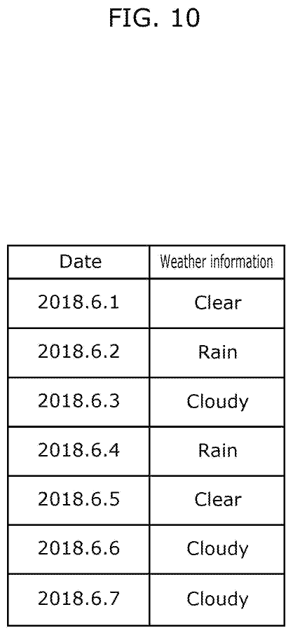

The weather information including current day weather information set in such a manner is stored in first memory 103. FIG. 10 illustrates one example of the weather information according to Embodiment 1. The weather information illustrated in FIG. 10 includes weather information for one week, including weather information for the current day (for example, Jun. 7, 2018).

When the weather information indicates cloudy (Yes in S1024), determiner 104 determines whether it is quiet in space 20 (S1025). More specifically, determiner 104 determines whether the sound level of sound collected by a microphone included in sensor group 300 is less than or equal to a threshold level. The threshold level indicates a loudness threshold for determining that space 20 is quiet. An empirically or experimentally predefined sound level can be used as the threshold level. Note that the determination of whether space 20 is quiet or not is not limited to the use of a microphone. For example, determiner 104 may determine whether space 20 is quiet or not based on the activity status of an electronic device that outputs sound (for example, a television, an audio device, a washing machine, or a vacuum cleaner or the like).

When determiner 104 determines that space 20 is quiet (Yes in S1025), determiner 104 determines that the first condition is satisfied (S1026). However, when the second return time is not later than the first return time by the first threshold amount of time or longer (No in S1021), when the user's idle time is not longer than or equal to the second threshold amount of time (No in S1022), when the user is not within the range of the given distance from a chair or sofa (No in S1023), when the weather information does not indicate cloudy (No in S1024), or when space 20 is determined to be not quiet (No in S1025), determiner 104 determines that the first condition is not satisfied (S1027).

Note that when the first condition includes only (i) and (ii) described above, and thus does not include (iii) and the others described above, steps S1023 through S1025 in FIG. 6 may be skipped.

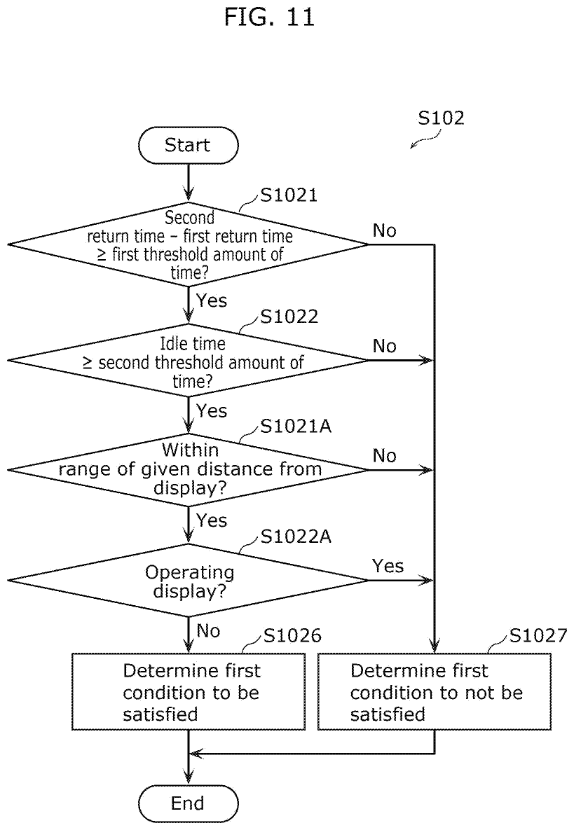

Note that the determination process for the first condition illustrated in FIG. 6 is merely one non-limiting example. If the first condition is different, the determination process is also different. Hereinafter, a variation of the determination process for the first condition will be described with reference to FIG. 11 through FIG. 14,

### First Variation of First Condition Determination Process

FIG. 11 is a flow chart illustrating a first variation of the determination process for the first condition according to Embodiment 1. In FIG. 11, in addition to (i) and (ii) described above, the first condition includes (iv) and (v) described below.

(iv) The user is near a display panel.
(v) The display panel is not being operated by the user.

If (i), (ii), (iv), and (v) described above are satisfied, it is estimated that there is a high probability that, in addition to the user being somewhat tired, the user will look if information is displayed on the display panel.

In FIG. 11, first, the same steps S1021 and S1022 that are in FIG. 6 are executed. Then, when the user's idle time is the second threshold amount of time or longer (Yes in S1022), determiner 104 determines whether the user is within a range of a given distance from the display panel (S1021A). In other words, determiner 104 determines whether (iv) described above is satisfied or not. Here, the given distance is a threshold distance for determining whether the user is capable of viewing information displayed on the display panel. An empirically or experimentally predefined distance can be used as the given distance, and, for example, a distance that varies depending on the size of the display panel may be used.

Since details regarding the process performed in step S1021A are the same as step S1023 illustrated in FIG. 6 except in regard to the display panel being used instead of a chair or sofa, repeated description thereof will be omitted.

When the user is within the range of the given distance from the display panel (Yes in S1021A), determiner 104 determines whether the display panel is being operated by the user (S1022A). In other words, determiner 104 determines whether (v) described above is satisfied or not. For example, determiner 104 can obtain, from the display panel, user operation information indicating past operations of the display panel by the user, and make the determination based on the obtained user operation information.

When the display panel is not being operated by the user (No in S1022A), determiner 104 determines that the first condition is satisfied (S1026). However, when the second return time is not later than the first return time by the first threshold amount of time or longer (No in S1021), when the user's idle time is not longer than or equal to the second threshold amount of time (No in S1022), when the user is not within the range of the given distance from the display panel (No in S1021A), or when the display panel is being operated by the user (Yes in S1022A), determiner 104 determines that the first condition is not satisfied (S1027).

### Second Variation of First Condition Determination Process

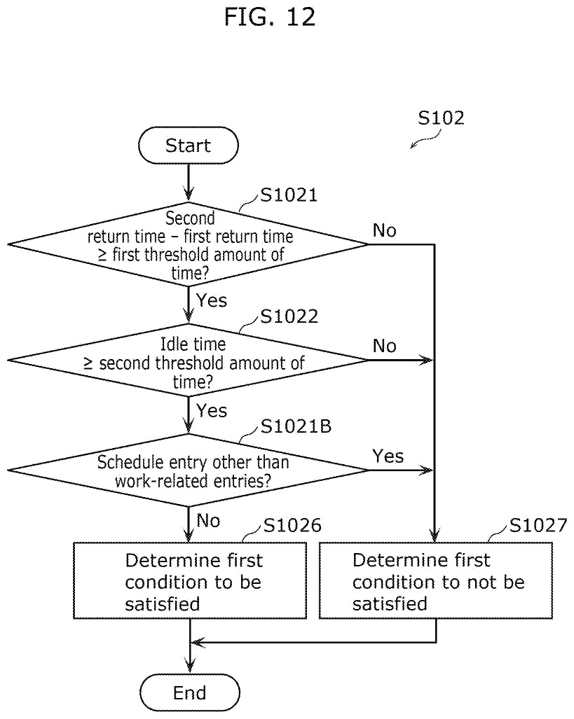

FIG. 12 is a flow chart illustrating a second variation of the determination process for the first condition according to Embodiment 1. In FIG. 12, in addition to (i) and (ii) described above, the first condition includes (vi) described below.

(vi) The schedule information does not include, in the second period, any entries other than work-related entries.

If (i), (ii), and (vi) described above are satisfied, it is estimated that there is a high probability that the user is somewhat tired and feels like he or she wants to have a break after continuous work events.

In FIG. 12, first, the same steps S1021 and S1022 that are in FIG. 6 are executed. When the user's idle time is the second threshold amount of time or longer (Yes in S1022), determiner 104 determines whether the schedule information includes, in the second period, any entries other than work-related entries (S1021B). In other words, determiner 104 determines whether (vi) described above is satisfied or not.

For example, the schedule information is obtained from an external server (not illustrated) that provides a schedule management function, and is stored in first memory 103. Accordingly, determiner 104 can obtain the user's schedule information from first memory 103.

When the schedule information does not include, in the second period, any entries other than work-related entries (No in S1021B), determiner 104 determines that the first condition is satisfied (S1026). However, when the second return time is not later than the first return time by the first threshold amount of time or longer (No in S1021), when the user's idle time is not longer than or equal to the second threshold amount of time (No in S1022), or when the schedule information does include, in the second period, any entries other than work-related entries (Yes in S1021B), determiner 104 determines that the first condition is not satisfied (S1027).

### Third Variation of First Condition Determination Process

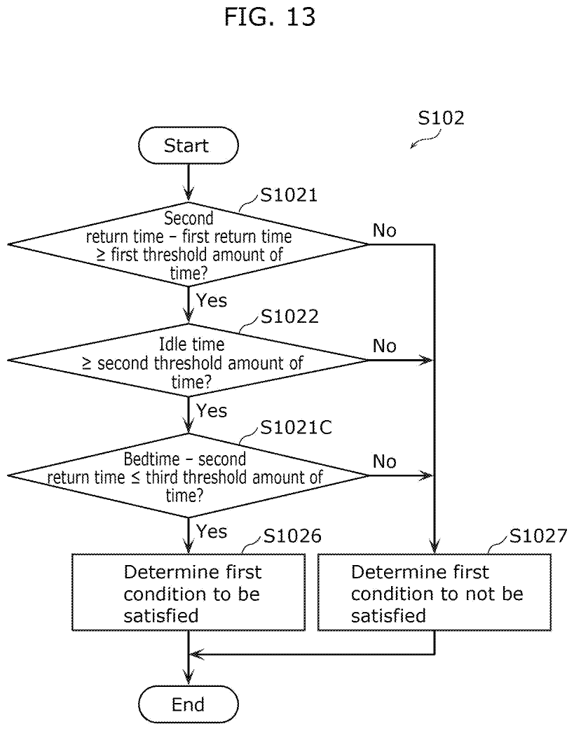

FIG. 13 is a flow chart illustrating a third variation of the determination process for the first condition according to Embodiment 1. In FIG. 13, in addition to (i) and (ii) described above, the first condition includes (vii) described below.

(vii) An amount of time from the second return time until a time the user goes to bed (bedtime) is a third threshold amount of time or less.

If (i), (ii), and (vii) described above are satisfied, it is estimated that the user is even more somewhat tired.

In FIG. 13, first, the same steps S1021 and S1022 that are in FIG. 6 are executed. When the user's idle time is the second threshold amount of time or longer (Yes in S1022), determiner 104 determines whether the amount of time from the second return time until the bedtime is the third threshold amount of time or less (S1021C). In other words, determiner 104 determines whether (vii) described above is satisfied or not.

The third threshold amount of time is an amount of time for determining that the length of time from when the user returns home until the user goes to bed is short. An empirically or experimentally predefined time may be used as the third threshold amount of time, and, alternatively, a time input in advance by the user may be used as the third threshold amount of time.

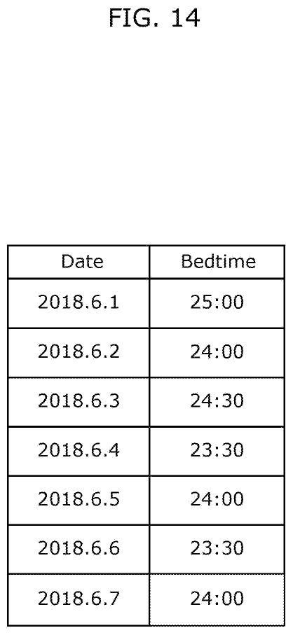

Here, the bedtime is a statistical bedtime based on the user's past bedtime data. Next, the statistical bedtime will be described in greater detail with reference to FIG. 14.

FIG. 14 illustrates one example of daily user bedtimes according to Embodiment 1. FIG. 14 illustrates the bedtime for each day from Jun. 1, 2018 to Jun. 7, 2018. Note that the bedtime need not be the exact bedtime; the bedtime may be a time rounded to a given unit of time (for example, 10 minutes, 30 minutes, or one hour).

The bedtimes illustrated in FIG. 14 can be obtained based on, for example, sensor data from a motion sensor disposed in the bedroom, a wearable sensor worn by the user, and a door sensor on the door of the bedroom. For example, based on the sensor data, it is possible to determine that the user has gone to bed when it is detected that the user has not moved in the bedroom for a given length of time (for example, 30 minutes) or longer and the lights in the bedroom are off.

Using the above-described daily bedtimes, a statistical value (for example, the average value or the mean value) of bedtimes over the third period in the past (for example, a week, a month, or three months back from the current day, or the same month from last year) is calculated as the statistical bedtime.

The third period need not be limited in particular, and may be a period of an empirically or experimentally predefined length. Statistical bedtimes calculated as described above are stored in first memory 103.

Outlier values may be removed from the population when the statistical bedtimes are calculated. An outlier value can be calculated using, for example, a known statistics method. Furthermore, bedtimes corresponding to weekdays or holidays may be removed from the population when the statistical bedtimes are calculated.

When determiner 104 determines that the amount of time from the second return time until the bedtime is the third threshold amount of time or less (Yes in S1021C), determiner 104 determines that the first condition is satisfied (S1026). However, when the second return time is not later than the first return time by the first threshold amount of time or longer (No in S1021), when the user's idle time is not longer than or equal to the second threshold amount of time (No in S1022), or when the amount of time from the second return time until the bedtime is longer than the third threshold amount of time (No in S1021C), determiner 104 determines that the first condition is not satisfied (S1027).

### Advantageous Effects, Etc.

As described above, the information providing method according to the present embodiment is a method that uses first information processing apparatus 100 which includes a processor and memory. A sensor is disposed in a home. The processor can: obtain, from the memory, information indicating a first return time indicating a time a user returned to the home in a first period in the past; obtain, from the memory, information indicating a second return time indicating a time the user returned to the home in a second period in the past, the second period being shorter than the first period; obtain movement information on the user, based on a sensor value of the sensor; when (i) the second return time is later than the first return time by a first threshold amount of time or longer and (ii) the movement information indicates that the user has not moved in the home for a second threshold amount of time or longer, generate first information indicating a high probability that the user is tired; obtain, from second information processing apparatus 200 connected to first information processing apparatus 100, information indicating first request content over a network; and when content of the first information is included in the first request content, output, to second information processing apparatus 200, second information including information for identifying the user or the home, using the first information generated.

This makes it possible to determine that there is a high probability that the user is tired, using past return times and movement information based on sensor values from sensors. Accordingly, it is possible to output information for identifying a user or home that is in such a situation to, for example, the service provider. As a result, it is possible for a service provider or the like to provide services appropriate for the situation of the user or home. It is therefore possible to effectively use sensor data to provide services.

Moreover, for example, in the information providing method according to the present embodiment, the processor may: obtain, from the memory, a map of the home including location information indicating a location of a chair or a sofa; and in the generating of the first information, when, in addition to (i) and (ii), (iii) the movement information indicates that the user is within a range of a given distance from the chair or the sofa, generate the first information.

This makes it possible to estimate that the user is tired and sitting in or leaning on a chair or sofa, and more definitely determine that there is a high probability that the user is tired.

Moreover, for example, in the information providing method according to the present embodiment, a device including a display may be disposed in the home, and in the generating of the first information, when, in addition to (i) and (ii), (iv) the movement information indicates that the user is near the display and (v) the display is not being operated by the user, the processor may generate the first information.

This makes it possible to determine that there is a high probability that the user is tired and service provision through the use of a display would be effective, and thus makes it possible to provide services suitable to the situation of the user or space 20.

Moreover, for example, in the information providing method according to the present embodiment, the processor may: obtain, from the memory, schedule information indicating a schedule of the user; and in the generating of the first information, when, in addition to (i) and (ii), (vi) the schedule information does not include, in the second period, any entries other than work-related entries, generate the first information.

This makes it possible to, using the schedule information, determine that there is a high probability that the user feels like he or she wants to have a break after continuous work events, and thus makes it possible to provide services further suitable to the situation of the user or space 20.

Moreover, for example, in the information providing method according to the present embodiment, the processor may further: obtain, from the memory, information indicating a bedtime indicating a time the user went to bed in a third period in the past; and in the generating of the first information, when, in addition to (i) and (ii), (vii) an amount of time from the second return time until the bedtime is a third threshold amount of time or less, generate the first information.

This makes it possible to determine that the user is returning home late every day and spending a short amount of time between returning home and going to bed, which makes it possible to more definitely determine that there is a high probability that the user is tired.

Note that the order of the determination steps illustrated in FIG. 6 and FIG. 11 through FIG. 13 is not limited to the illustrated order. For example, steps S1021 and S1022 may be performed in the reverse order, and, alternatively, may be performed in parallel.

### Embodiment 2

Next, Embodiment 2 will be described. The present embodiment mainly varies from Embodiment 1 in that the first information indicates that the user's activity is more delayed than usual, and that a different first condition is used to generate such first information. The present embodiment will be described with focus on the differences from Embodiment 1.

Note that the configuration of service providing system 10, the interactions in service providing system 10, and the processes performed by first information processing apparatus 100 according to the present embodiment are the same as in Embodiment 1, and will therefore be simplified or omitted in the illustrations and description.

### First Condition Determination Process

In the present embodiment, the first condition includes at least (viii) described below.

(viii) A first time is later than a second time by a given amount of time or longer, where the first time is included in current sensing information and indicates at least one of the user being present in the dining space or an electronic device being active, and the second time is included in past sensing statistical information and indicates at least one of the user being present in the dining space or the electronic device being active.

If (viii) described above is satisfied, it is estimated that the user's activity (for example, preparing to leave the home) is more delayed than usual. As used herein, “sensing information” refers to sensor data obtained from sensor group 300 as-is, or information obtained by processing the sensor data. Moreover, as used herein, “sensing statistical information” refers to information obtained by statistically processing sensing information.

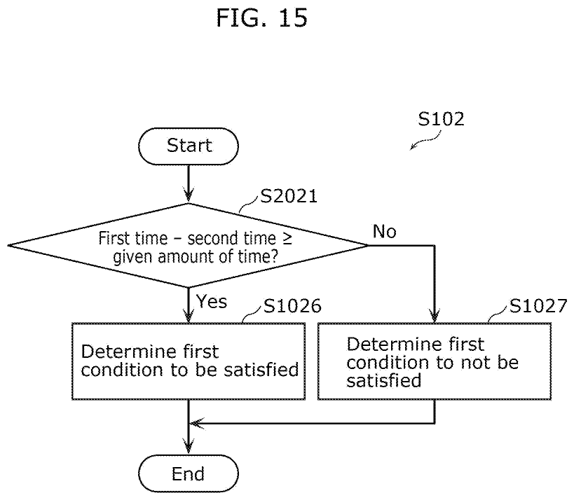

Next, the determination process for such a first condition (S102 in FIG. 5) will be described in greater detail with reference to FIG. 15. FIG. 15 is a flow chart illustrating one example of the determination process for the first condition (S102) according to Embodiment 2.

First, determiner 104 determines whether the first time is later than the second time by a given amount of time or longer (S2021). In other words, determiner 104 determines whether (viii) described above is satisfied or not.

The first time is the point in time included in the current sensing information (i.e., is the current time), and is a point in time that indicates at least one of the user being present in the dining space or an electronic device being active. The current sensing information is obtained from sensor group 300 disposed in the dining space included in space 20.

The second time is a point in time included in the past sensing statistical information (i.e., is a point in time in the past), and is a point in time that indicates at least one of the user being present in the dining space or an electronic device being active. The past sensing statistical information is obtained by implementing statistical processing on sensing information obtained in the past from sensor group 300 disposed in the dining space, and is stored in first memory 103.

The given amount of time is an amount of time for discerning that the user's activity is delayed. An empirically or experimentally predefined amount of time may be used as the given amount of time, and, alternatively, an amount of time input in advance by the user may be used.

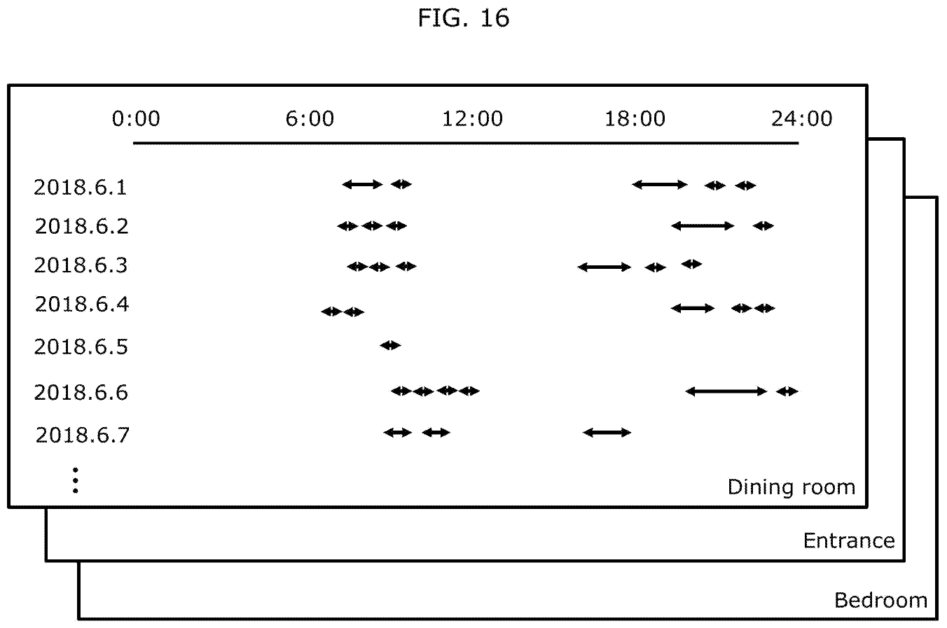

Next, the second time will be described in greater detail with reference to FIG. 16 through FIG. 18.

FIG. 16 illustrates one example of past sensing information related to the activity of an electronic device according to Embodiment 2. In FIG. 16, time is represented on the horizontal axis, and days are represented on the vertical axis. The double-headed arrows indicate the time that the electronic device is active.

The electronic device is included in device group 400 and is disposed in the dining space. Examples of the electronic device include a luminaire and a cooking appliance (for example, an induction cooktop, gas cooktop, a microwave oven, a rice cooker, or a coffee maker or the like).

A statistical value (for example, the average value or mean value) of start or end times of the earliest active time of the day from among all active times of the electronic device over a given span of time (for example, a week, a month, or three months back from the current day, or the same month from last year), can be calculated as the second time. The calculated second time is stored in first memory 103 as past sensing statistical information.

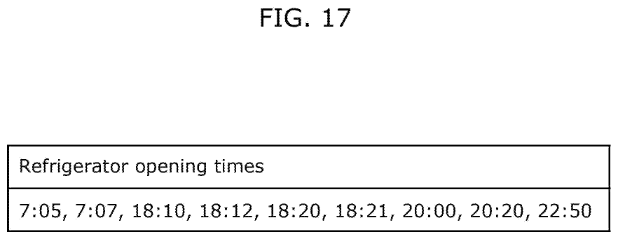

FIG. 17 illustrates one example of past sensing information related to the opening and closing of a door of a refrigerator according to Embodiment 2. FIG. 17 illustrates one example of times at which a door of a refrigerator was opened in a day.

The times at which a door of the refrigerator was opened that are illustrated in FIG. 17 can be obtained by, for example, a door sensor or an image sensor that captures images of the refrigerator. A statistical value (for example, the average value or mean value) of the earliest daily times at which a door of the refrigerator was opened over a given span of time (for example, a week, a month, or three months back from the current day, or the same month from last year), can be calculated as the second time. The calculated second time is stored in first memory 103 as past sensing statistical information.

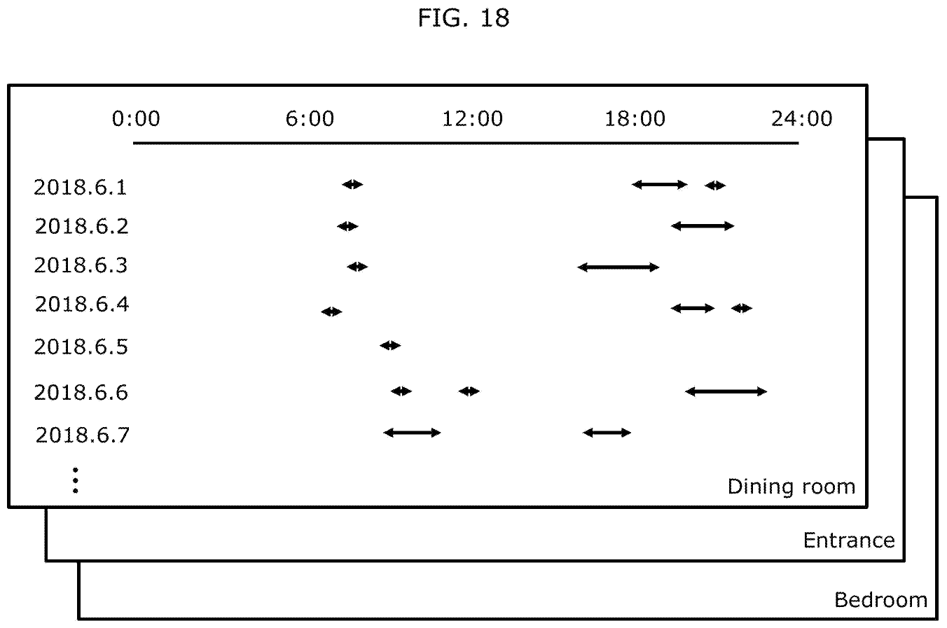

FIG. 18 illustrates one example of past sensing information obtained by the motion sensor according to Embodiment 2. In FIG. 18, time is represented on the horizontal axis, and days are represented on the vertical axis. The double-headed arrows indicate periods that a person was detected by the motion sensor (hereinafter referred to as detection periods). The motion sensor is included in sensor group 300 and is disposed in the dining space.

A statistical value (for example, the average value or mean value) of start or end times of the earliest detection period of the day from among all detection periods over a given span of time (for example, a week, a month, or three months back from the current day, or the same month from last year), can be calculated as the second time. The calculated second time is stored in first memory 103 as past sensing statistical information.

In the description of FIG. 16 through FIG. 18, in the calculation of the statistical value to be used as the second time, outlier time values may be removed from the population. An outlier value can be calculated using, for example, a known statistics method. Furthermore, times that fall on holidays may be removed from the population when the statistical value to be used as the second time is calculated.

We will now return to the description of the flowchart illustrated in FIG. 15. When the first time is later than the second time by the given amount of time or longer (Yes in S2021), determiner 104 determines that the first condition is satisfied (S1026). Consequently, processing from step S103 in FIG. 5 is performed. In this case, the first information generated in step S103 indicates that the user feels uneasy about a sound made outside space 20.

However, when the first time is not later than the second time by the given amount of time or longer (No in S2021), determiner 104 determines that the first condition is not satisfied (S1027). As a result, step S103 in FIG. 5 is skipped and step S111 and subsequent processes are executed.

### Service Information

For example, the first information is generated (S103), whether the first request is satisfied is determined (S112), and the second information is generated (S113), based on the result of determining whether the first condition is satisfied or not as described above, just like in Embodiment 1. Then, based on the second information, second information processing apparatus 200 generates and outputs the first service information for providing the first service to the user in space 20 via device group 400 (S121 and S122).

Here, as the first service, second information processing apparatus 200 can cause the display panel to display, for example, traffic information. This makes it possible to provide useful information to the user, and inhibit the user from arriving at his or her destination late.

### Advantageous Effects, Etc.

As described above, the information providing method according to the present embodiment is a method that uses first information processing apparatus 100 which includes a processor and memory. An electronic device and a sensor are disposed in a dining space of a home. The processor can: obtain, from the memory, past sensing statistical information corresponding to the dining space; obtain current sensing information corresponding to the dining space via the sensor; when (viii) a first time is later than a second time by a given amount of time or longer, generate first information indicating that an activity of a user is more delayed than usual, the first time being included in the current sensing information and indicating at least one of the user being present in the dining space or the electronic device being active, the second time being included in the past sensing statistical information and indicating at least one of the user being present in the dining space or the electronic device being active; obtain, from second information processing apparatus 200 connected to first information processing apparatus 100, information indicating first request content over a network; and when content of the first information is included in the first request content, output, to second information processing apparatus 200, second information including information for identifying the user or the home, using the first information generated.

This makes it possible to determine that the user's activity is more delayed than usual, using the current sensing information and the past sensing statistical information. Accordingly, it is possible to output information for identifying a user or home that is in such a situation to, for example, the service provider. As a result, it is possible for a service provider or the like to provide services appropriate for the situation of the user or home. It is therefore possible to effectively use sensor data to provide services.

Note that in the present embodiment, instead of the electronic device disposed in the dining space, the active times of a specified electronic device may be used. For example, a washing machine or vacuum cleaner or the like can be used as the specified electronic device. In such cases, first information processing apparatus 100 can generate, as the first information, information indicating that a specified task (for example, washing or vacuuming) is performed later (i.e., more delayed) than usual. In such cases, second information processing apparatus 200 can output, as the second service information, information advocating the so-called “slow movement” or information for reserving a beverage (for example, coffee) or food for takeout.

### Embodiment 3

Next, Embodiment 3 will be described. The present embodiment mainly varies from Embodiment 1 in that the first information indicates that the user has been in the dining space or entrance space longer than usual, and that a different first condition is used to generate such first information. The present embodiment will be described with focus on the differences from Embodiment 1.

Note that the configuration of service providing system 10, the interactions in service providing system 10, and the processes performed by first information processing apparatus 100 according to the present embodiment are the same as in Embodiment 1, and will therefore be simplified or omitted in the illustrations and description.

### First Condition Determination Process

In the present embodiment, the first condition includes at least (ix) described below.

(ix) A first amount of time is longer than a second amount of time by a given amount of time or longer, where the first amount of time is included in current sensing information and indicates at least one of: an amount of time that the user has been present in the dining space and/or the entrance space (hereinafter referred to as the “first space”); or an amount of time that the electronic device disposed in the first space has been active, and the second amount of time is included in past sensing statistical information and indicates at least one of: an amount of time that the user was present in the first space; or an amount of time that the electronic device was active.

If (ix) described above is satisfied, it is estimated that the user has been in the first space for longer than usual.

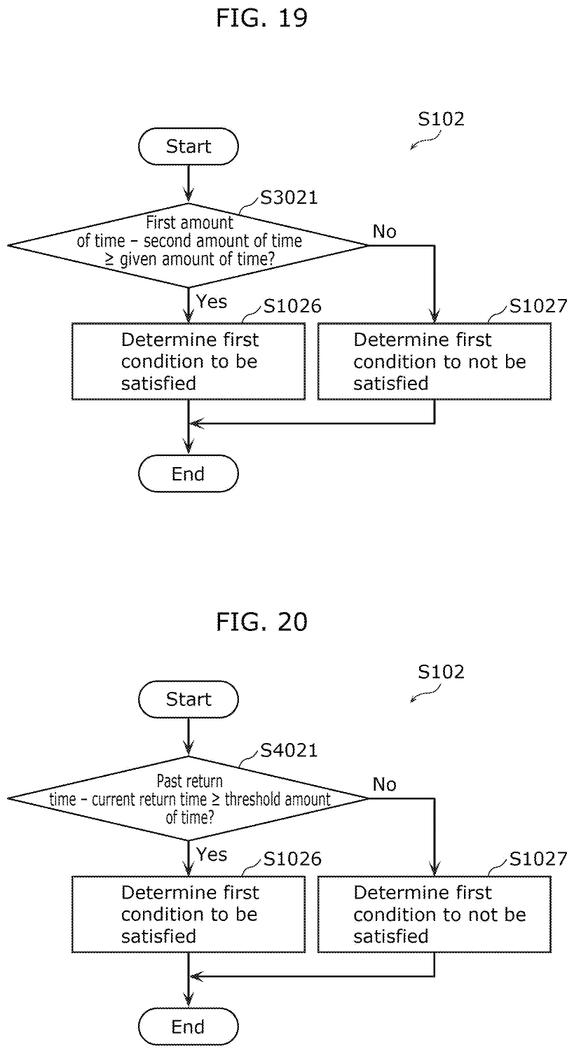

Next, the determination process for such a first condition (S102 in FIG. 5) will be described in greater detail with reference to FIG. 19. FIG. 19 is a flow chart illustrating one example of the determination process for the first condition (S102) according to Embodiment 3.

First, determiner 104 determines whether the first amount of time is longer than the second amount of time by a given amount of time or longer (S3021). In other words, determiner 104 determines whether an amount of time calculated by subtracting the second amount of time from the first amount of time is longer than or equal to the given amount of time. Stated differently, determiner 104 determines whether (ix) described above is satisfied or not.

The first amount of time is an amount of time that is included in the current sensing information and indicates at least one of an amount of time that the user has been present in the first space or an amount of time that the electronic device disposed in the first space has been operating. The current sensing information is obtained from sensor group 300 disposed in the dining space and/or the entrance space included in space 20.

The second amount of time is an amount of time that is included in the past sensing statistical information and indicates at least one of an amount of time that the user was present in the first space or an amount of time that the electronic device disposed in the first space was active. The past sensing statistical information is obtained by implementing statistical processing on sensing information obtained in the past from sensor group 300 disposed in the dining space and/or the entrance space included in space 20, and is stored in first memory 103.

More specifically, the second amount of time can be calculated from the past sensing information illustrated in FIG. 16 or FIG. 18, for example. For example, a statistical value (for example, the average value or the mean value) of a plurality of active times or detection periods in a given span of time (for example, a week, a month, or three months back from the current day, or the same month from last year) can be used as the second amount of time. The calculated second amount of time is stored in first memory 103 as past sensing statistical information. Note that outlier values of the active times or detection periods may be removed from the population.

The given amount of time is an amount of time for discerning that the user has been in the first space for longer than usual. An empirically or experimentally predefined amount of time may be used as the given amount of time, and, alternatively, an amount of time input in advance by the user may be used.

We will now return to the description of the flowchart illustrated in FIG. 19. When the first amount of time is longer than the second amount of time by the given amount of time or longer (Yes in S3021), determiner 104 determines that the first condition is satisfied (S1026). Consequently, processing from step S103 in FIG. 5 is performed. Here, the first information generated in step S103 indicates that the user has been in the first space for longer than usual.

However, when the first amount of time is not longer than the second amount of time by the given amount of time or longer (No in S3021), determiner 104 determines that the first condition is not satisfied (S1027). As a result, step S103 in FIG. 5 is skipped and step S111 and subsequent processes are executed.

### Service Information

For example, the first information is generated (S103), whether the first request is satisfied is determined (S112), and the second information is generated (S113), based on the result of determining whether the first condition is satisfied or not as described above, just like in Embodiment 1. Then, based on the second information, second information processing apparatus 200 generates and outputs the first service information for providing the first service to the user in space 20 via device group 400 (S121 and S122).

Here, as the first service, second information processing apparatus 200 can cause the display panel to display, for example, information related to waterproofing sprays.

### Advantageous Effects, Etc.

As described above, the information providing method according to the present embodiment is a method that uses first information processing apparatus 100 which includes a processor and memory. An electronic device and a sensor are disposed in a first space including at least one of an entrance space or a dining space of a home. The processor can: obtain, from the memory, past sensing statistical information corresponding to the first space; obtain current sensing information corresponding to the first space via the sensor; when (ix) a first amount of time is longer than a second amount of time by a given amount of time or longer, generate first information indicating that a user has been in the first space for longer than usual, the first amount of time being included in current sensing information and indicating at least one of an amount of time that the user has been present in the first space or an amount of time that the electronic device been active, the second amount of time being included in past sensing statistical information and indicating at least one of an amount of time that the user was present in the first space or an amount of time that the electronic device was active; obtain, from second information processing apparatus 200 connected to first information processing apparatus 100, information indicating first request content over a network; and when content of the first information is included in the first request content, output, to second information processing apparatus 200, second information including information for identifying the user or the home, using the first information generated.

This makes it possible to determine that the user has been in the entrance space and/or the dining space for longer than usual, using the current sensing information and the past sensing statistical information. Accordingly, it is possible to output information for identifying a user or home that is in such a situation to, for example, the service provider. As a result, it is possible for a service provider or the like to provide services appropriate for the situation of the user or home. It is therefore possible to effectively use sensor data to provide services.

### Embodiment 4

Next, Embodiment 4 will be described. The present embodiment mainly varies from Embodiment 1 in that the first information indicates that the user has returned home earlier than usual, and that a different first condition is used to generate such first information. The present embodiment will be described with focus on the differences from Embodiment 1.

Note that the configuration of service providing system 10, the interactions in service providing system 10, and the processes performed by first information processing apparatus 100 according to the present embodiment are the same as in Embodiment 1, and will therefore be simplified or omitted in the illustrations and description.

### First Condition Determination Process

In the present embodiment, the first condition includes at least (x) described below.

(x) A time at which the user returned home that is included in the current sensing information is earlier than a time at which the user returned home that is included in the past sensing statistical information by a threshold amount of time or longer.

If (x) described above is satisfied, it is estimated that the user has returned home earlier than usual.

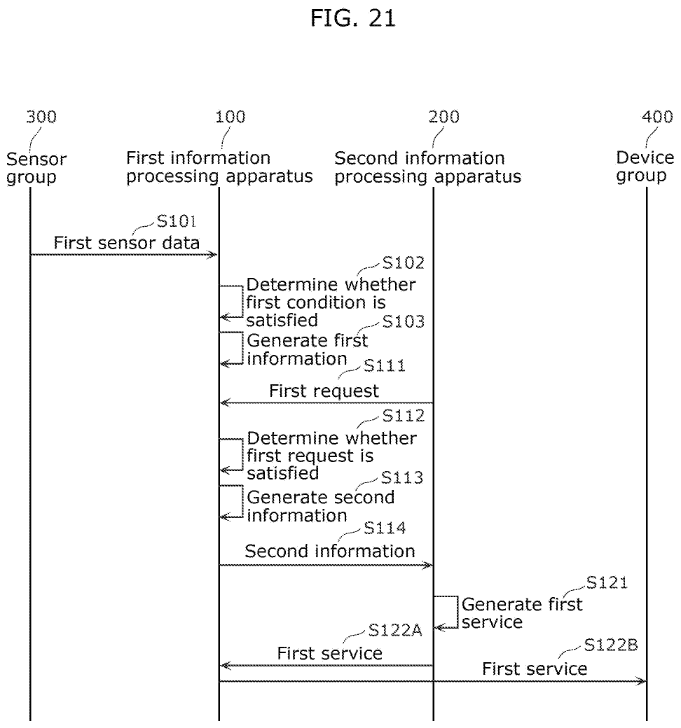

Next, the determination process for such a first condition (S102 in FIG. 5) will be described in greater detail with reference to FIG. 20. FIG. 20 is a flow chart illustrating one example of the determination process for the first condition (S102) according to Embodiment 4.

First, determiner 104 determines whether the current return time is earlier than a past return time by a given amount of time or longer (S4021). In other words, determiner 104 determines whether the amount of time calculated by subtracting the current return time from the past return time is longer than or equal to the given amount of time. Stated differently, determiner 104 determines whether (x) described above is satisfied or not.

The current return time is a point in time included in the current sensing information (i.e., the current time), and indicates the time at which the user returned home. The current sensing information is obtained from sensor group 300 disposed in the entrance space included in space 20.

The past return time is a point in time included in the past sensing statistical information (i.e., a point in time in the past), and indicates the time at which the user returned home in the past. The past sensing statistical information is obtained by implementing statistical processing on sensing information obtained in the past from sensor group 300 disposed in the entrance space included in space 20, and is stored in first memory 103. Since the past return time can be obtained in the same manner as the first return time described in Embodiment 1, repeated detailed description thereof will be omitted.

The given amount of time is an amount of time for discerning that the use has returned home early. An empirically or experimentally predefined amount of time may be used as the given amount of time, and, alternatively, an amount of time input in advance by the user may be used.

When the current return time is earlier than the past return time by the given amount of time or longer (Yes in S4021), determiner 104 determines that the first condition is satisfied (S1026). Consequently, processing from step S103 in FIG. 5 is performed. Here, the first information generated in step S103 indicates that the user has returned home earlier than usual.

However, when the current return time is not earlier than the past return time by the given amount of time or longer (No in S4021), determiner 104 determines that the first condition is not satisfied (S1027). As a result, step S103 in FIG. 5 is skipped and step S111 and subsequent processes are executed.

### Service Information

For example, the first information is generated (S103), whether the first request is satisfied is determined (S112), and the second information is generated (S113), based on the result of determining whether the first condition is satisfied or not as described above, just like in Embodiment 1. Then, based on the second information, second information processing apparatus 200 generates and outputs the first service information for providing the first service to the user in space 20 via device group 400 (S121 and S122).

For example, here, second information processing apparatus 200 can, as the first service, turn on a luminaire in space 20. Second information processing apparatus 200 can also recommend a piece of healing music as the first service.

### Advantageous Effects, Etc.

As described above, the information providing method according to the present embodiment is a method that uses first information processing apparatus 100 which includes a processor and memory. A sensor is disposed in an entrance space of a home. The processor can: obtain, from the memory, past sensing statistical information corresponding to the entrance space; obtain current sensing information corresponding to the entrance space via the sensor; when (x) a time at which a user returned home that is included in the current sensing information is earlier than a time at which the user returned home that is included in the past sensing statistical information by a threshold amount of time or longer, generate first information indicating that the user has returned home earlier than usual; obtain, from second information processing apparatus 200 connected to first information processing apparatus 100, information indicating first request content over a network; and when content of the first information is included in the first request content, output, to second information processing apparatus 200, second information including information for identifying the user or the home, using the first information generated.

This makes it possible to determine that the user has returned home earlier than usual, using the current sensing information and the past sensing statistical information. Accordingly, it is possible to output information for identifying a user or home that is in such a situation to, for example, the service provider. As a result, it is possible for a service provider or the like to provide services appropriate for the situation of the user or home. It is therefore possible to effectively use sensor data to provide services.

Note that instead of the stipulation that the current return time be earlier than the past return time by the given amount of time or longer, a stipulation that the current return time be later than the past return time by a given amount of time or longer may be included in the first condition. In such cases, the first information indicates that the user has returned home later than usual.

### Variation 1

Next, Variation 1 of the above embodiments will be described. The present variation mainly varies from the embodiments in that services are provided via first information processing apparatus 100. The present variation will be described with reference to the figures, with focus on the differences from the embodiments.

Note that since the configurations of service providing system 10 according to the present variation are the same as in the above embodiments, repeated illustration and description will be omitted.

### Interaction in Service Providing System 10

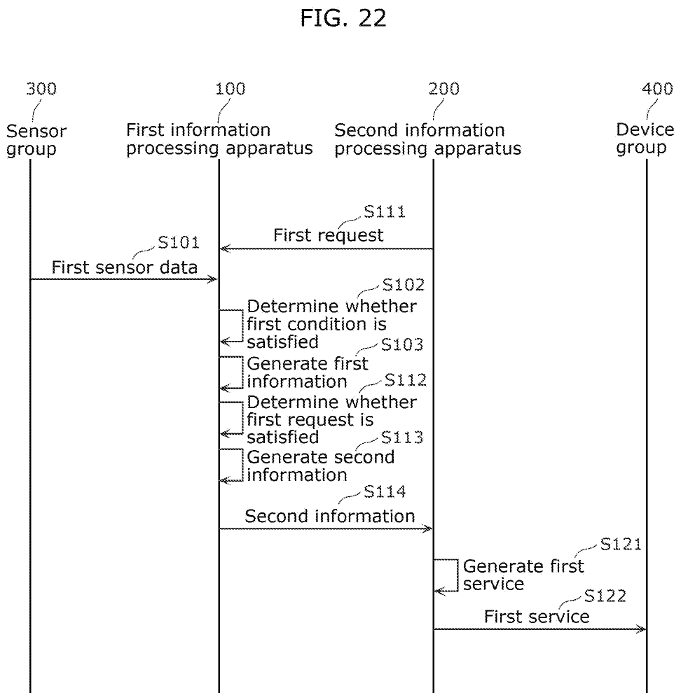

FIG. 21 is a sequence diagram for service providing system 10 according to Variation 1. As illustrated in FIG. 21, after generating the first service information (S121), second information processing apparatus 200 according to the present variation outputs the first service information to first information processing apparatus 100 (S122A). First information processing apparatus 100 transfers the first service information obtained from first information processing apparatus 100 to device group 400 (S122B). First information processing apparatus 100 may transmit record information on the provision of the first service information to second information processing apparatus 200. Examples of the record information include the number of times that the first service information has been provided, and attribute information related to a user or space 20. Attribute information is information that cannot identify a user or space 20. Examples of attribute information include geographical information on the user and demographics of the user. Note that the record information may be limited to information that has been permitted to be transmitted by the user in advance.

### Advantageous Effects, Etc.

As described above, with service providing system 10 according to the present variation, second information processing apparatus 200 can restrict disclosure of information related to space 20 to second information processing apparatus 200 since it is not necessary to directly communicate with device group 400 disposed in space 20. Accordingly, the privacy of users in space 20 can be protected.

### Variation 2

Next, Variation 2 of the above embodiments will be described. The present variation mainly varies from the above embodiments in that the transmission of the first request information from second information processing apparatus 200 to first information processing apparatus 100 is performed before, rather than after, the generation of the first information (S103). The present variation will be described with reference to the figures, with focus on the differences from the embodiments.

Note that since the configurations of service providing system 10 according to the present variation are the same as in the above embodiments, repeated illustration and description will be omitted.

### Interaction in Service Providing System 10

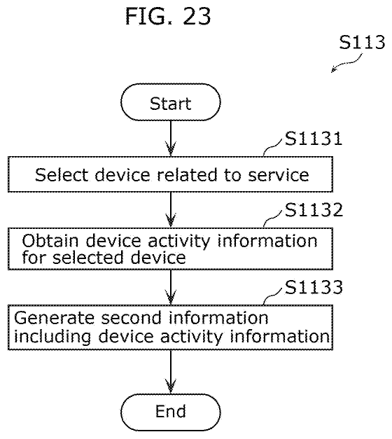

FIG. 22 is a sequence diagram for service providing system 10 according to Variation 2. As illustrated in FIG. 22, first information processing apparatus 100 according to the present variation obtains the first request information (S111) before obtaining the first sensor data (S101).

It is sufficient so long as the obtainment of the first request information (S111) is performed before the determining of whether the first request is satisfied (S112); the obtainment of the first request information (S111) is not limited to being performed before the obtainment of the first sensor data (S101). Moreover, since the first request has already been transmitted, second information processing apparatus 200 may request to obtain information regarding when to determine whether the first condition is satisfied (S102). If the first sensor data is consecutively received in a time series and whether the first condition is satisfied or not (S102) is determined upon each instance of reception of the first sensor data, it may be possible to obtain information at the point in time that the situation changes in a way to satisfy the first condition, by obtaining first sensor data information that does not meet the first condition immediately before first data that does satisfy the first condition is received. For example, the second information may be first sensor data information that (i) is obtained immediately before the first condition is satisfied and (ii) does not satisfy the first condition. Moreover, first information processing apparatus 100 may suggest to second information processing apparatus 200 to change the first condition, depending on the result of an analysis of statistical information on the first sensor data information that (i) is obtained immediately before the first condition is satisfied and (ii) does not satisfy the first condition.

### Advantageous Effects, Etc.

As described above, with service providing system 10 according to the present variation, it is possible to output the second information regardless of the timing of the obtainment of the first request information, and possible to provide second information that is timely.

### Variation 3

Next, Variation 3 of the above embodiments will be described. The present variation mainly varies from the above embodiments in that the second information includes, in addition to information for identifying a user or space, device activity information for a device related to a service. The present variation will be described with reference to the figures, with focus on the differences from the embodiments.

Note that since the configurations of service providing system 10 according to the present variation are the same as in the above embodiments, repeated illustration and description will be omitted. The interaction in service providing systems 10 and 10A and the processes performed by first information processing apparatus 100 are as illustrated in FIG. 6 through FIG. 9. Accordingly, repeated illustration and description will be simplified or omitted.

### Process for Generating Second Information

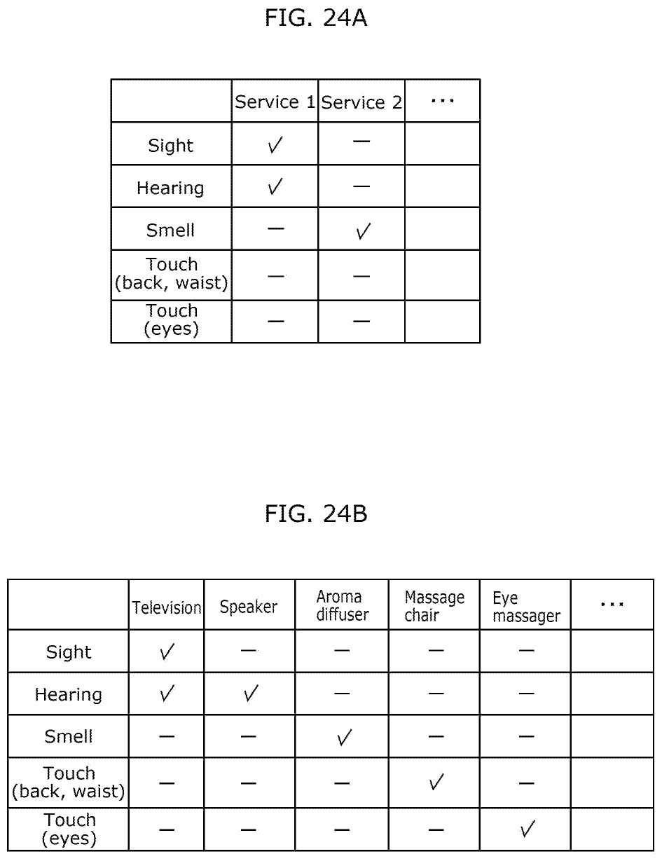

Next, the process for generating the second information (S113 in FIG. 5) according to the present variation will be described in greater detail with reference to FIG. 23. FIG. 23 is a flow chart illustrating one example of the process for generating the second information (S113) according to Variation 3. Note that in the present variation, the first request information includes information for identifying the service provided by second information processing apparatus 200.

First information processing apparatus 100 selects a device related to the service identified by the first request information from among device group 400 disposed in space 20 in which the first information was generated (S1131). For example, first information processing apparatus 100 selects a device from among device group 400 based on the effect the service has on the user's five senses (sight, hearing, smell, touch, and taste) and the effect the device has on the user's five senses.

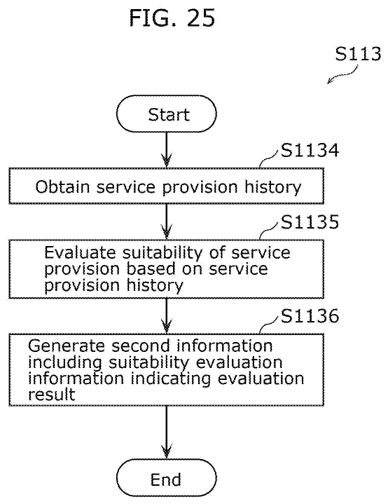

FIG. 24A illustrates one example of information indicating relationships between services and the five senses. FIG. 24B illustrates one example of information indicating relationships between devices and the five senses. In FIG. 24A and FIG. 24B, a check indicates that the service or device affects the corresponding sense, and a dash indicates that the service or device does not affect the corresponding sense.

For example, FIG. 24A shows that service 1 affects the senses of sight and hearing and does not affect the senses of smell or touch (back, waist, and eyes). For example, FIG. 24B shows that the television affects the senses of sight and hearing and does not affect the senses of smell or touch (back, waist, and eyes).

When, for example, service 1 is identified by the first request information, first information processing apparatus 100 selects, from among the devices illustrated in FIG. 24B, the television and the speaker which are associated with the sense of sight or the sense of hearing that are affected by service 1 as illustrated in FIG. 24A.

Next, first information processing apparatus 100 obtains device activity information for the selected device(s) (S1132). The device activity information is information indicating whether the device is active. For example, the device activity information may be obtained directly from the device(s), or may be obtained via a sensor or sensors.

First information processing apparatus 100 then generates the second information including the device activity information (S1133).

### Advantageous Effects, Etc.

As described above, according to the present variation, it is possible for the second information to include the device activity information for a device. Accordingly, second information processing apparatus 200 can provide a service that activates a device in an inactive state, and can avoid competition with services for devices that are operating. For example, when there are many devices that are in an active state, second information processing apparatus 200 can avoid causing multiple devices to confuse the senses of the user.

Although the second information includes the device activity information for selected devices in the present variation, this example is non-limiting. For example, the second information may include the device activity information for all devices. Moreover, the device activity information may be output separately from the second information.

The second information may moreover include only device activity information for devices that have been permitted to provide the device activity information by the user. Moreover, when there is a device that has been denied permission to provide the device activity information by the user, the second information may include information indicating that the device has been denied permission to provide the device activity information by the user. For example, when second information processing apparatus 200 provides a service using a device that has been denied permission to provide the operation information by the user, second information processing apparatus 200 may request permission from the user to provide the service.

### Variation 4

Next, Variation 4 of the above embodiments will be described. The present variation mainly varies from the above embodiments in that the second information includes, in addition to information for identifying a user or space, suitability information indicating service provision suitability. The present variation will be described with reference to the figures, with focus on the differences from the embodiments.

Note that since the configurations of service providing system 10 according to the present variation are the same as in the above embodiments, repeated illustration and description will be omitted. The interaction in service providing systems 10 and 10A and the processes performed by first information processing apparatus 100 are as illustrated in FIG. 6 through FIG. 9. Accordingly, repeated illustration and description will be simplified or omitted.

### Process for Generating Second Information

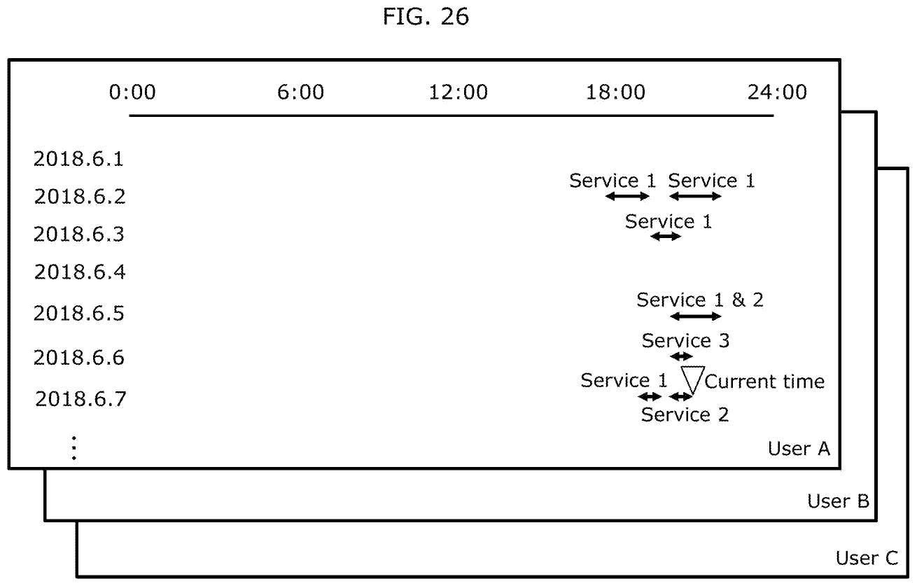

Next, the process for generating the second information (S113 in FIG. 5) according to the present variation will be described in greater detail with reference to FIG. 25. FIG. 25 is a flow chart illustrating one example of the process for generating the second information (S113) according to Variation 4. Note that in the present variation, the first request information includes information for identifying the service provided by second information processing apparatus 200.

First information processing apparatus 100 obtains a service provision history for space 20 or the user (S1134). Service provision history is information associating services provided in the past to space 20 or the user with the date and time that those services were provided.

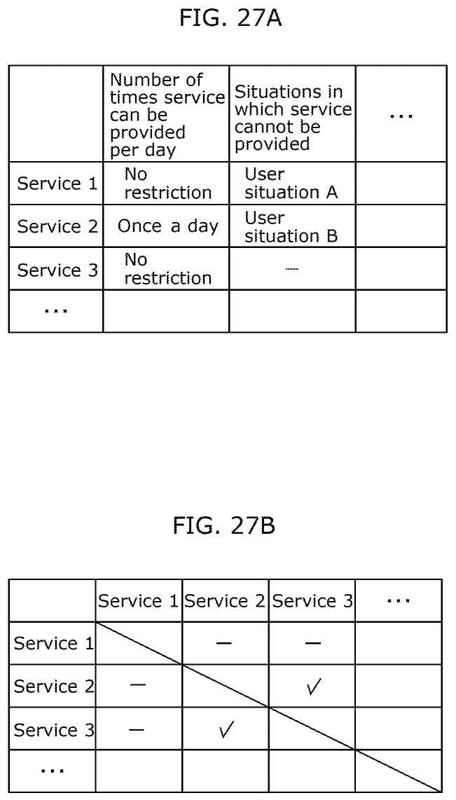

FIG. 26 illustrates one example of the service provision history according to Variation 4. In FIG. 26, time is represented on the horizontal axis, and days are represented on the vertical axis. The double-headed arrows indicate the time that a service was or will be provided to space 20 or the user. For example, service 1 was provided twice between 18:00 and 24:00 on Jun. 2, 2018. Note that the service provision history can include a plurality of different services provided by a plurality of different second information processing apparatuses 200 (in other words, a plurality of different service providers).

Next, first information processing apparatus 100 evaluates the suitability of the provision of the service identified by the first request information for space 20 or the user, based on the obtained service provision history (S1135). More specifically, for example, first information processing apparatus 100 evaluates the suitability of the provision of the service identified by the first request information based on the number of times the service was provided in a given span of time. As another example, first information processing apparatus 100 may evaluate the suitability of the provision of the service identified by the first request information based on another service that is currently being provided.

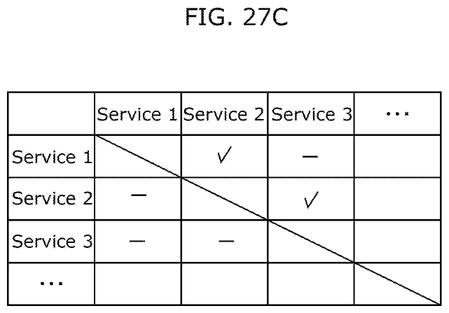

Next, specific examples of the evaluation of the suitability of the service provision will be given with reference to FIG. 27A through FIG. 27C. FIG. 27A illustrates one example of service provision availability information according to Variation 4. For example, service provision availability information may be stored in advance in third memory 107, and, alternatively, may be obtained from an external server (not illustrated in the figures).

The service provision availability information indicates, for each service, the number of times per day that service can be provided, as well as situations in which that service cannot be provided. For example, the service provision availability information illustrated in FIG. 27A indicates that service 1 and service 3 both have no restrictions for how many times they can be provided per day, and that service 2 can only be provided once a day.

According to the service provision history illustrated in FIG. 26, on the current day (Jun. 7, 2018), service 1 and service 2 have already been provided. Accordingly, based on the service provision availability information illustrated in FIG. 27A, the suitability of the provision of services 1 and 3 is evaluated high, and the suitability of the provision of service 2 is evaluated low.

Moreover, the service provision availability information illustrated in FIG. 27A indicates that services 1 and 2 cannot be provided in user situations A and B, respectively. For example, the situation in which the user's activity is more delayed than usual in Embodiment 2 may be used as user situations A and B. In such cases, by prohibiting the provision of less urgent services (for example, music playback or providing horoscope information), it is possible to provide services suitable to the user's situation. Moreover, a situation in which the user is in the dining space or entrance space longer than usual may be used as user situations A and B.

FIG. 27B illustrates one example of information indicating services that are prohibited from being provided simultaneously according to Variation 4. For example, the information indicating services that are prohibited from being provided simultaneously may be stored in advance in third memory 107, and, alternatively, may be obtained from an external server (not illustrated in the figures).

The information indicating services that are prohibited from being provided simultaneously indicates, more specifically, pairs of services that are prohibited from being or allowed to be provided simultaneously. A check indicates the two services are prohibited from being provided simultaneously, while a dash indicates the two services are allowed to be provided simultaneously.

For example, the information illustrated in FIG. 27B indicates that service 1 is allowed to be provided simultaneously with services 2 and 3. In other words, service 1 can be provided along with each of service 2 and service 3. For example, the information illustrated in FIG. 27B also indicates that service 2 is prohibited from being provided simultaneously with service 3. In other words, the information indicates that service 2 cannot be provided along with service 3.

FIG. 27C illustrates one example of information indicating services that are prohibited from being changed according to Variation 4. For example, the information indicating services that are prohibited from being changed may be stored in advance in third memory 107, and, alternatively, may be obtained from an external server (not illustrated in the figures).

The information indicating services that are prohibited from being changed indicates, more specifically, services prohibited from being or allowed to be provided in place of a service that is already being provided. A check indicates that changing from the service on the left column to the service on the top row is prohibited, and a dash indicates that changing from the service on the left column to the service on the top row is allowed.

For example, in FIG. 27C, when service 1 is currently being provided, changing from service 1 to service 2 is prohibited. On the other hand, when service 2 is currently being provided, changing from service 2 to service 1 is allowed. Moreover, when service 2 is currently being provided, changing from service 2 to service 3 is also prohibited.

In the service provision history illustrated in FIG. 26, service 2 is being provided at the current time. However, based on the information indicating services that are prohibited from being provided simultaneously that is illustrated in FIG. 27B and the information indicating services that are prohibited from being changed that is illustrated in FIG. 27C, the suitability of the provision of service 1 is evaluated high and the suitability of the provision of service 3 is evaluated low.

Such an evaluation result is expressed as two or more levels. For example, two levels, namely “suitable” and “unsuitable”, can be used as the evaluation result. As another example, a number score from 0 to 10 or 0 to 100 can be used as the evaluation result.

Lastly, first information processing apparatus 100 generates the second information including suitability evaluation information indicating the evaluation result (S1136).

### Advantageous Effects, Etc.

As described above, according to the present variation, it is possible for the second information to include suitability evaluation information. Accordingly, second information processing apparatus 200 can, for example, skip the provision of a service when the service's suitability evaluation is low, and can thus inhibit the provision of services at inappropriate times. As a result, service providing systems 10 and 10A can reduce excessive provision of services and inhibit interference between services.

Although the second information includes the suitability evaluation information in the present variation, this example is non-limiting. For example, in addition to or instead of the suitability evaluation information, the second information may include the service provision history information. Moreover, the service suitability information may be output separately from the second information.

### Variation 5

Next, Variation 5 of the above embodiments will be described. The present variation mainly varies from the above embodiments in that, when first requests having the same request content have already been received from a plurality of second information processing apparatuses 200 (see Variation 2 above), the second information is output to a second information processing apparatus 200 selected based on priority level. The present variation will be described with reference to the figures, with focus on the differences from the embodiments.

Note that since the configurations of service providing system 10 according to the present variation are the same as in the above embodiments, repeated illustration and description will be omitted. The interaction in service providing systems 10 and 10A and the processes performed by first information processing apparatus 100 are as illustrated in FIG. 6 through FIG. 9. Accordingly, repeated illustration and description will be simplified or omitted.

### Process for Outputting Second Information

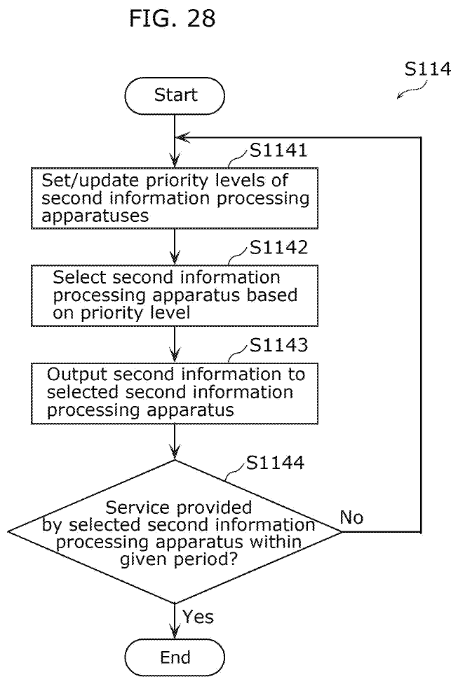

Next, the process for outputting the second information (S114 in FIG. 5) according to the present variation will be described in greater detail with reference to FIG. 28. FIG. 28 is a flow chart illustrating one example of the process for outputting the second information (S114) according to Variation 5.

First information processing apparatus 100 sets the priority level of each of a plurality of second information processing apparatuses 200 (S1141). In other words, first information processing apparatus 100 sets the priority level for each of a plurality of second information processing apparatuses 200 that correspond to a plurality of first requests having the same request content. For example, the priority levels may be included in the first request information, and in such cases, the priority levels are set according to the priority levels included in the first request information. The priority levels may be set according to the situation of space 20 or the user that is obtained from sensor group 300 and device group 400. Moreover, the priority levels of the plurality of second information processing apparatuses 200 may be set based on bid amounts by the service providers for the provision of the second information.

Next, first information processing apparatus 100 selects one or more second information processing apparatuses 200 based on the set priority level (S1142). For example, first information processing apparatus 100 selects, from among a plurality of second information processing apparatuses 200 that correspond to a plurality of first requests having the same request content, the second information processing apparatus 200 having the highest priority level. Note that the number of second information processing apparatuses 200 selected is not limited to one.

First information processing apparatus 100 then outputs the second information to the selected second information processing apparatus 200 (S1143). Thereafter, first information processing apparatus 100 determines whether the service has been provided by the selected second information processing apparatus 200 within a given period (S1144). In other words, whether or not the selected second information processing apparatus 200 has provided the service within a given period starting when the second information is output is determined. An empirically or experimentally predefined period can be used as the given period. For example, the same period may be used across a plurality of services. Alternatively, individually set times for the plurality of services may be used as the given period.

When the service is provided within the given period (Yes in S1144), processing ends. However, when the service is not provided within the given period (No in S1144), processing proceeds to step S1141. This time in step S1141, the priority levels of the plurality of second information processing apparatuses 200 are updated such that the priority level of the second information processing apparatus 200 that did not provide the service is reduced. First information processing apparatus 100 then selects one or more second information processing apparatuses 200 based on the updated priority levels (S1142). Here, the system may be configured so that the service can only be provided to the user or space 20 when the priority level is set to the highest level. For example, if the second information is sent to both the second information processing apparatus 200 set to the highest priority level before the update and the second information processing apparatus 200 set to the highest priority level after the update, there is a chance that the service may be redundantly provided when, after a given period, the service is attempted to be provided by the second information processing apparatus 200 set to the highest priority level before the update. Accordingly, the system may be set so that only the second information processing apparatus 200 set to the highest priority level can use the second information. For example, this may be achieved by setting the system so that the second information may only be used at the time the service is executed, so that the encryption is changed after each update, and providing an encryption key corresponding to the second information processing apparatus 200 set to the highest priority level.

### Advantageous Effects, Etc.

As described above, according to the present variation, first information processing apparatus 100 can select a second information processing apparatus 200 based on priority level. Accordingly, service providing systems 10 and 10A can select a second information processing apparatus 200 that is appropriate for the provision of the service from among a plurality of second information processing apparatuses 200 corresponding to a plurality of first requests having the same request content.

### Types of Services

Next, the types of services in the service providing system according to the above embodiments will be described.

### Overview of Provided Services

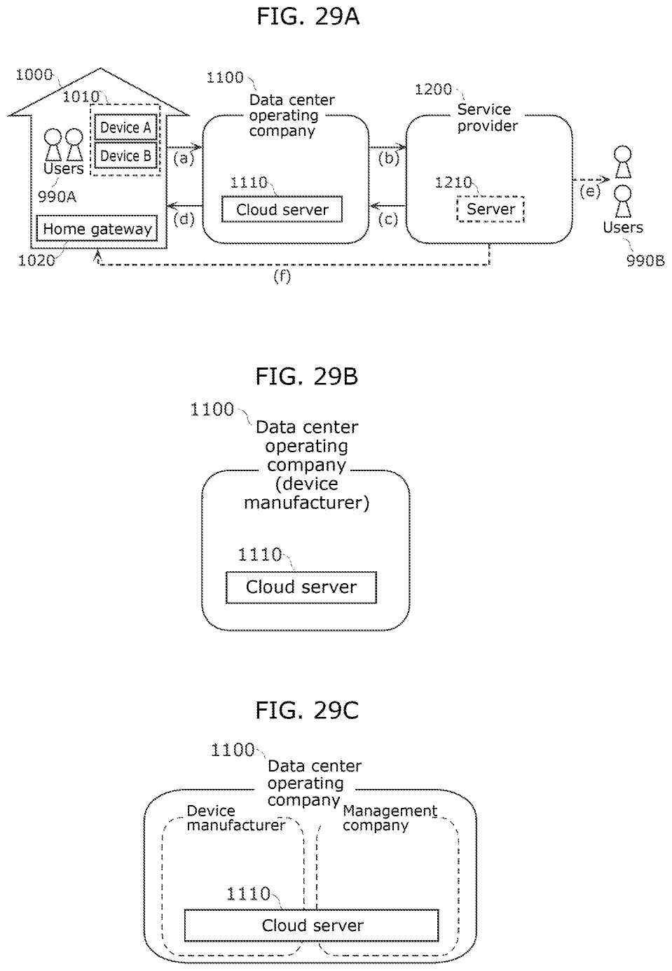

FIG. 29A illustrates an overview of the service providing system.

Group 1000 is, for example, a business, an organization, or a household or the like. The scale of group 1000 may be any scale. Group 1000 includes devices A and B included in plural devices 1010, and home gateway 1020. For example, plural devices 1010 are devices included in device group 400 according to the above embodiments. For example, home gateway 1020 is gateway 500 according to the above embodiments. Plural devices 1010 include devices that can connect to the internet (for example, smartphones, PCs, televisions, etc.) as well as devices that cannot connect to the internet themselves (for example, lights, washing machines, etc.). Even devices that cannot connect to the internet themselves but can connect to the internet via home gateway 1020 may be included. Moreover, user(s) 990A that use plural devices 1010 are in group 1000.

Data center operating company 1100 includes cloud server 1110. Cloud server 1110 is a virtual server that links with various devices over the internet. For example, cloud server 1110 is first information processing apparatus 100 according to the above embodiments. For example, cloud server 1110 manages big data which is difficult to manage with typical database management tools. Data center operating company 1100 performs operations of a data center, such as data management and management of cloud server 1110. Services performed by data center operating company 1100 will be described in greater detail later. Here, data center operating company 1100 is not limited to a company that only performs operations such as data management and operation of cloud server 1110. For example, when a device manufacturer that develops and produces one device among plural devices 1010 also performs data management and management of cloud server 1110, that device manufacturer corresponds to data center operating company 1100 (FIG. 29B). Moreover, data center operating company 1100 is not limited to a single company. For example, when a device manufacturer and another management company work in consort or through shared contribution to carry out the data management and operation of cloud server 1110, both or one of the device manufacturer and the management company corresponds to data center operating company 1100 (FIG. 29C).

Service provider 1200 has server 1210. As used herein, the scale of server 1210 may be any scale. For example, server 1210 may be memory included in a personal computer. Moreover, there are cases in which service provider 1200 does not have server 1210. For example, server 1210 is second information processing apparatus 200 according to the above embodiments.

Note that home gateway 1020 is not required in the service described above. For example, when cloud server 1110 does all of the data management, home gateway 1020 is not necessary. Furthermore, there are cases in which there are no devices that cannot connect to the internet themselves, such as when all household devices are connected to the internet.

Next, the flow of information in the above service will be described.

First, device A and device B in group 1000 transmit information they obtained to cloud server 1110 in data center operating company 1100. Cloud server 1110 accumulates the information from device A or device B ((a) in FIG. 29A). The accumulated information is information indicating, for example, the operation status, operating date and time, operation mode, position, etc., of plural devices 1010. Examples include, but are not limited to, television viewing history, television video recorder scheduled recordings, washing machine operating date and time, washing machine laundry amount, date and time that the door of a refrigerator opened or closed, number of times that the door of a refrigerator opened or closed, and amount of food in a refrigerator; the accumulated information includes any information that can be obtained from any kind of device. There are cases in which the information is provided directly to cloud server 1110 from plural devices 1010 themselves via the internet. The information may be obtained from plural devices 1010 and intermediately accumulated by home gateway 1020, from where it is provided to cloud server 1110.

Next, cloud server 1110 in data center operating company 1100 provides the accumulated information to service provider 1200 in fixed units. Here, fixed units may be units in which the data center operating company can organize the collected information and provide the collected information to service provider 1200, and may be units requested by service provider 1200. Although the term “fixed units” is used herein, the units need not be fixed; the amount of information provided may be variable according to the situation. The information is stored in server 1210 of service provider 1200 ((b) in FIG. 29A). Service provider 1200 then organizes the information to suit the service to be provided to the user, and then provides it to the user. The user on the receiving end may be user 990A that uses plural devices 1010, and may be external user(s) 990B. The method of providing the service to the user may be a method whereby the service is provided directly from the service provider, for example ((e), (f) in FIG. 29A). Alternatively, the method of providing the service to the user may be a method whereby the service is provided to the user via cloud server 1110 in data center operating company 1100 ((c), (d) in FIG. 29A). Moreover, cloud server 1110 in data center operating company 1100 may organize the information to suit the service to be provided to the user, and then provide the information to service provider 1200.

Note that user 990A and user 990B may be the same or different users.

For example, the techniques described above can be realized in the following types of cloud services. However, the techniques described above are not limited to being realized in the following examples.

### Service Type 1: In-Company Data Center

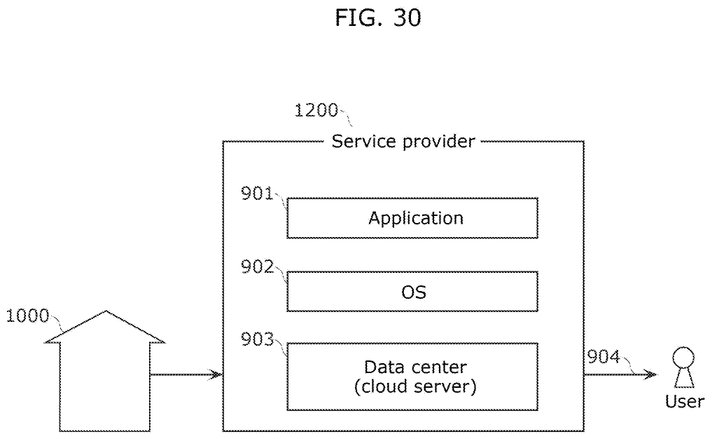

FIG. 30 illustrates service type 1 (in-company data center). In this type, service provider 1200 obtains information from group 1000 and provides a service to a user. In this type, service provider 1200 functions as a data center operating company. In other words, the service provider has cloud server 1110 that manages big data. Accordingly, there is no data center operating company.

In this type, service provider 1200 operates and manages data center 903 (cloud server 1110). Service provider 1200 also manages OS 902 and application 901. Service provider 1200 provides service 904 using OS 902 and application 901 that it manages.

### Service Type 2: IaaS

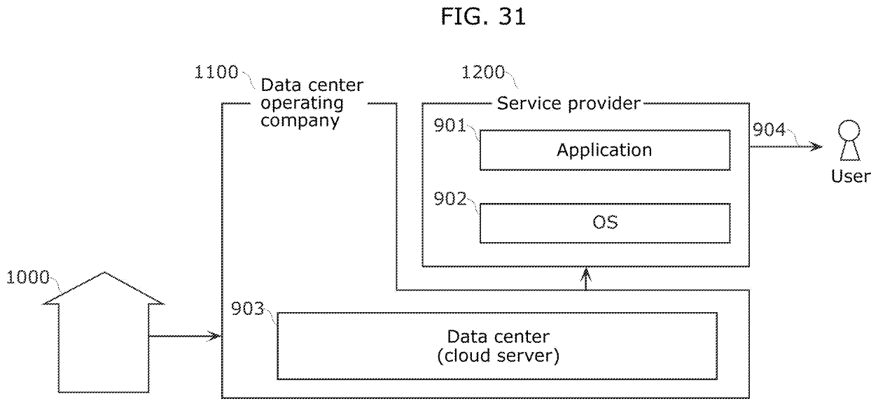

FIG. 31 illustrates service type 2 (IaaS). As used herein, “IaaS” stands for infrastructure as a service, and refers to a cloud service provision model that provides an infrastructure for constructing and operating a computer system, as a service via the internet.

In this type, data center operating company 1100 operates and manages data center 903 (cloud server 1110). Service provider 1200 also manages OS 902 and application 901. Service provider 1200 provides service 904 using OS 902 and application 901 that it manages.

### Service Type 3: PaaS

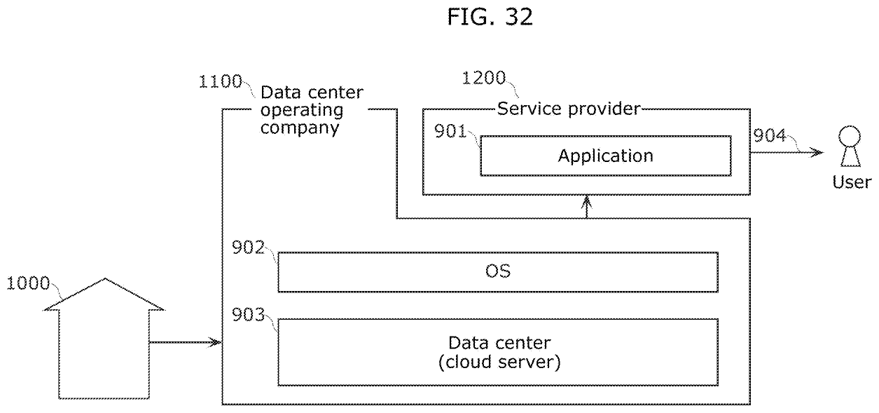

FIG. 32 illustrates service type 3 (PaaS). As used herein, “PaaS” stands for platform as a service, and refers to a cloud service provision model that provides a platform for constructing and operating software, as a service via the internet.

In this type, data center operating company 1100 manages OS 902 and operates and manages data center 903 (cloud server 1110). Service provider 1200 also manages application 901. Service provider 1200 provides service 904 using OS 902 managed by the data center operating company and application 901 that itself manages.

### Service Type 4: SaaS

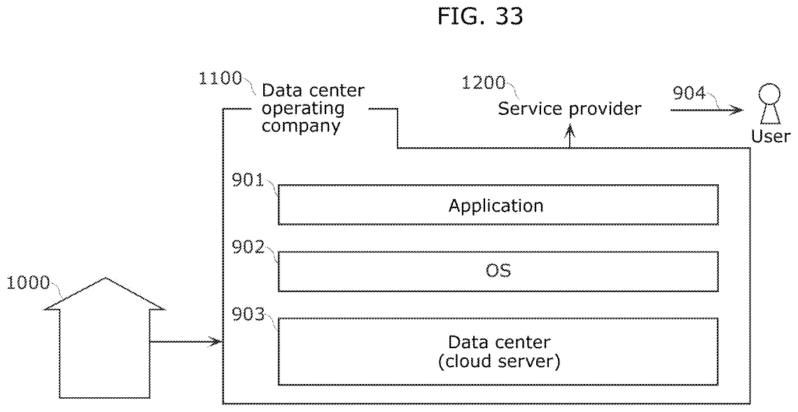

FIG. 33 illustrates service type 4 (SaaS). As used herein, “SaaS” stands for software as a service. For example, SaaS refers to a cloud service provision model that, for example, has a function that allows a company or individual (user) that does not have a data center (cloud server) to use, over a network such as the internet, an application provided by a platform provider that has a data center (cloud server).

In this type, data center operating company 1100 manages application 901, manages OS 902, and operates and manages data center 903 (cloud server 1110). Service provider 1200 provides service 904 using OS 902 and application 901 that data center operating company 1100 manages.

In any of the above types, the service provision is performed by service provider 1200. Moreover, for example, the service provider or the data center operating company may develop, for example, the OS, application, or database of big data themselves, or may outsource the OS, application, or database of big data from a third party.

### OTHER EMBODIMENTS

Although the service providing system according to one or more aspects of the present disclosure has been described based on embodiments, the present disclosure is not limited to these embodiments. Those skilled in the art will readily appreciate that various modifications may be made in these exemplary embodiments and that other embodiments may be obtained by arbitrarily combining the elements of the embodiments without materially departing from the novel teachings and advantages of the subject matter of the present disclosure. Accordingly, all such modifications and other embodiments are included in one or more aspects of the present disclosure.

For example, in the embodiments above, first information processing apparatus 100 that processes the sensor data and second information processing apparatus 200 that generates the service information are provided as separate apparatuses, but first information processing apparatus 100 and second information processing apparatus 200 may be configured as a single information processing apparatus. In such cases, since there is no need for interaction between first information processing apparatus 100 and second information processing apparatus 200, when the first condition is satisfied, processes from the generation of the first information to the output of the second information may be skipped.

### INDUSTRIAL APPLICABILITY

The techniques of the present disclosure can be used as an information processing apparatus that provides information for providing a service to a user.

1. An information providing method that uses a first information processing apparatus which includes a processor and memory,
wherein a sensor is disposed in a home, and
the processor:
obtains, from the memory, information indicating a first return time indicating a time a user returned to the home in a first period in the past;
obtains, from the memory, information indicating a second return time indicating a time the user returned to the home in a second period in the past, the second period being shorter than the first period;
obtains movement information on the user, based on a sensor value of the sensor;
when (i) the second return time is later than the first return time by a first threshold amount of time or longer and (ii) the movement information indicates that the user has not moved in the home for a second threshold amount of time or longer, generates first information indicating a high probability that the user is tired;
obtains, from a second information processing apparatus connected to the first information processing apparatus, information indicating first request content over a network; and
when content of the first information is included in the first request content, outputs, to the second information processing apparatus, second information including information for identifying the user or the home, using the first information generated.

2. The information providing method according to claim 1,
wherein the processor:
obtains, from the memory, a map of the home including location information indicating a location of a chair or a sofa; and
in the generating of the first information, when, in addition to (i) and (ii), (iii) the movement information indicates that the user is within a range of a given distance from the chair or the sofa, generates the first information.

3. The information providing method according to claim 1,
wherein a device including a display is disposed in the home, and
in the generating of the first information, when, in addition to (i) and (ii), (iv) the movement information indicates that the user is near the display and (v) the display is not being operated by the user, the processor generates the first information.

4. The information providing method according to claim 1,
wherein the processor:
obtains, from the memory, schedule information indicating a schedule of the user; and
in the generating of the first information, when, in addition to (i) and (ii), (vi) the schedule information does not include, in the second period, any entries other than work-related entries, generates the first information.

5. The information providing method according to claim 1,
wherein the processor, further:
obtains, from the memory, information indicating a bedtime indicating a time the user went to bed in a third period in the past; and
in the generating of the first information, when, in addition to (i) and (ii), (vii) an amount of time from the second return time until the bedtime is a third threshold amount of time or less, generates the first information.

6. An information providing method that uses a first information processing apparatus which includes a processor and memory,
wherein an electronic device and a sensor are disposed in a dining space of a home, and
the processor:
obtains, from the memory, past sensing statistical information corresponding to the dining space;
obtains current sensing information corresponding to the dining space via the sensor;
when (viii) a first time is later than a second time by a given amount of time or longer, generates first information indicating that an activity of a user is more delayed than usual, the first time being included in the current sensing information and indicating at least one of the user being present in the dining space or the electronic device being active, the second time being included in the past sensing statistical information and indicating at least one of the user being present in the dining space or the electronic device being active;
obtains, from a second information processing apparatus connected to the first information processing apparatus, information indicating first request content over a network; and
when content of the first information is included in the first request content, outputs, to the second information processing apparatus, second information including information for identifying the user or the home, using the first information generated.

7. An information providing method that uses a first information processing apparatus which includes a processor and memory,
wherein an electronic device and a sensor are disposed in a first space including at least one of an entrance space or a dining space of a home, and
the processor:
obtains, from the memory, past sensing statistical information corresponding to the first space;
obtains current sensing information corresponding to the first space via the sensor;
when (ix) a first amount of time is longer than a second amount of time by a given amount of time or longer, generates first information indicating that a user has been in the first space for longer than usual, the first amount of time being included in current sensing information and indicating at least one of an amount of time that the user has been present in the first space or an amount of time that the electronic device been active, the second amount of time being included in past sensing statistical information and indicating at least one of an amount of time that the user was present in the first space or an amount of time that the electronic device was active;
obtains, from a second information processing apparatus connected to the first information processing apparatus, information indicating first request content over a network; and
when content of the first information is included in the first request content, outputs, to the second information processing apparatus, second information including information for identifying the user or the home, using the first information generated.

8. An information providing method that uses a first information processing apparatus which includes a processor and memory,
wherein a sensor is disposed in an entrance space of a home, and
the processor:
obtains, from the memory, past sensing statistical information corresponding to the entrance space;
obtains current sensing information corresponding to the entrance space via the sensor;
when (x) a time at which a user returned home that is included in the current sensing information is earlier than a time at which the user returned home that is included in the past sensing statistical information by a threshold amount of time or longer, generates first information indicating that the user has returned home earlier than usual;
obtains, from a second information processing apparatus connected to the first information processing apparatus, information indicating first request content over a network; and
when content of the first information is included in the first request content, outputs, to the second information processing apparatus, second information including information for identifying the user or the home, using the first information generated.
